(19) United States
(12) Patent Application Publication
(10) Pub. No.: US 2018/0211046 A1
(43) Pub. Date: Jul. 26, 2018

(54) ANALYSIS AND CONTROL OF CODE FLOW AND DATA FLOW

(71) Applicant: Intel Corporation, Santa Clara, CA (US)

(72) Inventors: Igor G. Muttik, Berkhamsted (GB); Ravi L. Sahita, Portland, OR (US)

(73) Assignee: Intel Corporation, Santa Clara, CA (US)

(21) Appl. No.: 15/416,934

(22) Filed: Jan. 26, 2017

(51) Int. Cl. G06F 21/57; G06F 9/30

(52) U.S. Cl. CPC G06F 21/577; G06F 8/53; G06F 9/30058

(57) ABSTRACT

Technologies are provided in embodiments to analyze and control execution flow. At least some embodiments include decompiling object code of a software program on an endpoint to identify one or more branch instructions, receiving a list of one or more modifications associated with the object code, and modifying the object code based on the list and the identified one or more branch instructions to create new object code. The list of one or more modifications is based, at least in part, on telemetry data related to an execution of corresponding object code on at least one other endpoint. In more specific embodiments, a branch instruction of the one or more branch instructions is identified based, at least in part, on an absence of an instruction in the object code that validates the branch instruction.

### TECHNICAL FIELD

This disclosure relates in general to the field of software security, and more particularly, to dynamic code flow control with telemetry feedback and to combined code flow and data flow analysis and control.

### BACKGROUND

The field of software security has become increasingly important in today's society. Computer systems have become intertwined in everyday life, while malicious software (‘malware’) that can disrupt and even prevent the use of computer systems has become increasingly more sophisticated. Reducing the number of bugs in software programs has become critical because certain software bugs can lead to exploitable vulnerabilities. For example, certain logic flaws can be exploited to change the flow of execution in a software program. To harden software and make it more reliable, certain hardware capabilities have been developed to enforce correct execution flow. For example, shadow stack and Control-Flow Enforcement Technology (CET) instructions can be used to harden new software programs to help reduce potential bugs in the programs. Software developers face significant challenges, however, in hardening existing software to minimize or eliminate bugs in the software.

Modern computer systems are also vulnerable to data leaks. Certain types of data leaks (e.g., financial data, confidential and private information, company secrets, etc.) can create significant issues for individuals and entities alike. Data leaks may be caused by unauthorized code execution attacks as well as software bugs that enable intentional or inadvertent exploitation of these vulnerabilities in the software. Mitigating techniques that are based on recognizing and blocking unauthorized code can be rendered ineffective when attackers develop new techniques to overcome existing approaches. Moreover, there is no reliable and efficient data-flow tracking in software at run-time. Thus, computer systems could benefit from new solutions that prevent data leaks caused by unauthorized code execution of software programs and that provide guarantees of code flow and data flow correctness.

### BRIEF DESCRIPTION OF THE DRAWING

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a telemetry feedback system for dynamically controlling code flow in a software program according to an embodiment of the present disclosure;

FIG. 2 is a simplified block diagram illustrating additional details and interactions of components of the telemetry feedback system according to an embodiment of the present disclosure;

FIG. 3 is a simplified flowchart of potential operations associated with a telemetry feedback system according to an embodiment of the present disclosure;

FIG. 4 is a simplified flowchart of further potential operations associated with a telemetry feedback system according to an embodiment of the present disclosure;

FIG. 5 is a simplified flowchart of further potential operations associated with a telemetry feedback system according to an embodiment of the present disclosure;

FIG. 6 is a simplified flowchart of further potential operations associated with a telemetry feedback system according to an embodiment of the present disclosure;

FIG. 7 is a simplified flowchart of further potential operations associated with a telemetry feedback system according to an embodiment of the present disclosure;

FIG. 8 is a simplified block diagram of a security-enabled computing system for analyzing and controlling code flow and data flow of a software program in a software program according to an embodiment of the present disclosure;

FIG. 9 is a simplified block diagram illustrating additional details of components of the security-enabled computing system according to an embodiment of the present disclosure;

FIG. 10 is a simplified flowchart of potential operations associated with a security-enabled computing system according to an embodiment of the present disclosure;

FIG. 11 is a block diagram of a memory coupled to an example processor according to an embodiment;

FIG. 12 is a block diagram of an example computing system that is arranged in a point-to-point (PtP) configuration according to an embodiment; and

FIG. 13 is a simplified block diagram associated with an example ARM ecosystem system on chip (SOC) according to an embodiment.

### DETAILED DESCRIPTION OF EMBODIMENTS

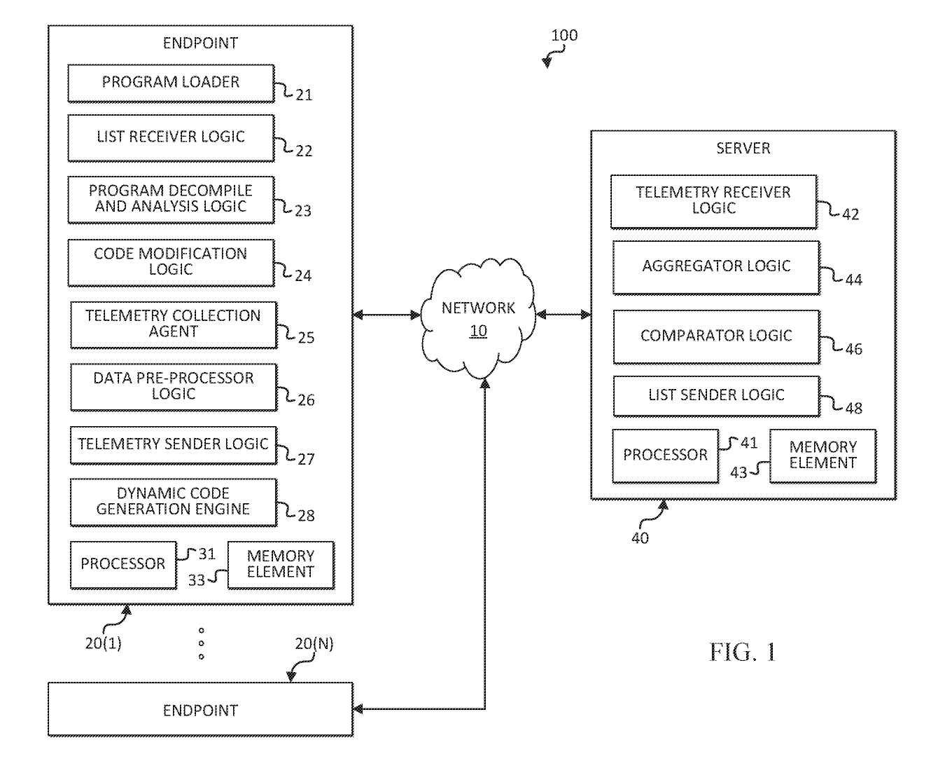

FIG. 1 is a simplified block diagram of an example telemetry feedback system 100 for dynamically controlling code flow in a software program. Telemetry feedback system 100 includes endpoints 20(1)-20(N) and a server 40. In at least one embodiment, endpoints 20(1)-20(N) and server 40 may communicate via one or more networks, such as network 10. Endpoint 20(1) is representative of certain components that may be included in each endpoint (e.g., 20(1) through 20(N)) in telemetry feedback system 100. Endpoint 20(1) can include a program loader 21, list receiver logic 22, program decompile and analysis logic 23, code modification logic 24, telemetry collection agent 25, data pre-processor logic 26, telemetry sender logic 27, and dynamic code generation logic 28. Server 40 can include telemetry receiver logic 42, aggregator logic 44, comparator logic 46, and sender logic 48. Endpoints 20(1)-20(N) and server 40 may also include logical or physical hardware elements such as processor 31 and memory element 33 in endpoint 20(1) and processor 41 and memory element 43 in server 40.

Elements of FIG. 1 may be coupled to one another through one or more interfaces employing any suitable connections (wired or wireless), which provide viable pathways for network communications. Additionally, any one or more of these elements of FIG. 1 may be combined or removed from the architecture based on particular configuration needs. Telemetry feedback system 100 may include a configuration capable of transmission control protocol/internet protocol (TCP/IP) communications for the transmission and/or reception of packets in a network. Telemetry feedback system 100 may also operate in conjunction with a user datagram protocol/IP (UDP/IP) or any other suitable protocol, where appropriate and based on particular needs.

For purposes of illustrating certain example techniques of a telemetry feedback system, it is important to understand the activities that may be occurring in such systems. The following foundational information may be viewed as a basis from which the present disclosure may be properly explained.

Some software bugs can lead to exploitable vulnerabilities in a software program running on an endpoint. A software program may also be referred to herein as a ‘program’. Generally, a software bug is an error, mistake, flaw, defect or fault in a software program or system that may cause failure, deviation from expected results, or unintended behavior. Example effects of bugs can include, but are not limited to, causing a software program to crash, allowing a malicious user to bypass access controls and obtain unauthorized privileges to an endpoint or network, allowing access to confidential or sensitive data, or causing a software program to propagate malware to other endpoints or networks.

A code reuse attack is a type of software exploit enabled by certain software bugs. In a code reuse attack, an attacker can direct control of a program flow through existing code with an unauthorized or unwanted result. For example, if a logic flaw exists in the program, then an attacker that is aware of the flaw or how to exploit that vulnerability can change the flow of execution in a program. Code reuse emerged as a form of malware due to the general success of other security techniques in preventing execution of object code on the heap or stack.

One technique by which a code reuse attack has been implemented is return-oriented programming (ROP). A binary of a program to be exploited can be pre-analyzed to find portions of code that can be executed. These executable portions may or may not normally be executed by the program, but can be selectively executed using ROP. In this scenario, the final sequences of code that are executed may deviate from the normal sequence of code and may perform malicious or otherwise unintended or unwanted operations. More specifically, ROP uses return instructions that are part of the instruction set. Return instructions can operate on the stack, and if the stack is corrupted, then the program flow on the next return can potentially be directed to a different place than the original intent of the code. Consequently, an attacker can use existing return op codes in the program to execute different executable portions of code to achieve a desired, potentially malicious result.

Other techniques may also be exploited for code reuse. For example, call-oriented programming (COP) and jump-oriented programming (JOP) are variances of the ROP technique, and can also be used to perform a code reuse attack on a program. COP uses a call instruction and JOP uses a jump instruction. A call instruction can operate on information in memory that, if corrupted, could cause the call to go to a different location than the intended location. A jump instruction operates on information in memory that, if corrupted, could cause the flow to go to an unintended location in memory that is executable, but executing at random offsets in the program. Generally, there is no enforcement by a computing system to control branches within the code used in ROP, COP and JOP.

Control-flow Enforcement Technology (CET) is a new technology offered by Intel Corporation of Santa Clara, Calif. to protect against code reuse attacks. CET is designed to harden software and make it more reliable. In particular, CET provides new central processing unit (CPU) capabilities to enforce correct execution flow using a shadow stack and designated CET instructions, such as an ENDBRANCH instruction. In CET, a shadow stack is used for control transfer (also referred to herein as ‘branch’) operations in addition to the traditional stack used for control transfer and data. For example, a CALL instruction pushes the return address to the shadow stack in addition to the traditional stack. A return instruction, such as RET, pops the return address from both the shadow stack and the traditional stack. Control is transferred to the return address if the return addresses popped from both stacks match.

In CET, a particular instruction such as ENDBRANCH can be used to enforce correct execution control. An ENDBRANCH instruction is an instruction added to the instruction set architecture (ISA) for CET to mark a valid target for an indirect branch or jump. An indirect branch instruction specifies where the address of the next instruction to execute is located, rather than a direct branch, which specifies the actual address of the next instruction to execute. If ENDBRANCH is not a target of an indirect branch or jump, the CPU can generate an exception indicating a malicious or unintended operation has occurred. In an example CET use case, a compiler generates operation code (also referred to herein as ‘object code’) from a high-level programming language (e.g., C++, scripted-oriented language, etc.) and injects an ENDBRANCH instruction at every expected control transfer point (also referred to herein as ‘branch point’) of the object code (e.g., where a program performs a call, any kind of jump, return, software interrupt, etc.).

The injection of ENDBRANCH instructions is performed when a software program is built. Consequently, legacy programs, as well as software built with legacy compilers, generally do not benefit from a compiler's CET hardening of software programs. One technique to address legacy programs involves decompiling object code of a legacy software program and injecting ENDBRANCH instructions where needed. This approach presents risks, however, because assumptions are made and missed ENDBRANCH instruction locations can create unprotected code branches. This scenario can allow attackers to construct exploits and/or cause runtime exceptions. An approach is needed for CET to avoid incorrect and missing ENDBRANCH injections into legacy binaries.

Embodiments disclosed herein can resolve the aforementioned issues (and more) associated with dynamic code flow control using telemetry feedback. In telemetry feedback system 100, a technique of injecting validation instructions into binaries (also referred to herein as ‘object code’) is combined with aggregating telemetry data from multiple endpoints to learn about code flows and field exceptions. In one example, a validation instruction is an ENDBRANCH instruction. Telemetry feedback is used to discover potential branch points within a code flow and use this knowledge to correct and improve placement of validation instructions, which each serve to validate a portion of the code flow (e.g., validating a branch point). The validation instructions can be inserted statically into object code on disk or loaded in memory before execution, or dynamically using techniques like binary translation or rewriting the binary code, for example. One or more types of telemetry data can be gathered for each process from multiple endpoints. Examples of telemetry data can include a CPU's last branch record (LBR), a processor trace that reports instruction pointers on branches (e.g., target instruction pointer or TIP), and addresses of exceptions from incorrect flows (e.g., a branch point with no ENDBRANCH instruction).

Telemetry feedback system 100 provides several advantages. Use of system 100 can cleanse an ecosystem from modern code-reuse exploits that have emerged due to a drastic increase in software resistance to other types of exploits. In addition, user experience can improve due to minimizing exceptions in software related to CET technology before software is recompiled. The system also facilitates better compiler support for CET due to telemetry feedback, which allows fixing compiler bugs related to code flow control. Telemetry feedback system 100 also generates rich telemetry about unexpected code flows that can provide knowledge about ROP, COP, and JOP exploitations in the field. Telemetry feedback system 100 can operate on all software, with or without source code. In addition, software hardening is increased by telemetry feedback system because it allows wider ENDBRANCH instruction coverage while reducing the impact of mistakes. The risk of software hardening is reduced due to rapid fixing of ENDBRANCH instructions that are incorrectly injected into legacy object code. Moreover, telemetry feedback system 100 may simplify compilers if proposed dynamic code-flow enforcement is used as a standalone technique to prevent code-reuse. Finally, embodiments disclosed herein are capable of working statically, dynamically, and silently by adding or removing validation instructions, such as ENDBRANCH, in programs at rest (e.g., portable execution (PE) file on disk) or dynamically (e.g., injection by the loader after creating a program image in memory, etc.)

Turning to FIG. 1, a brief discussion is now provided about some of the possible infrastructure that may be included in telemetry feedback system 100. Generally, telemetry feedback system 100 can include any type or topology of networks, indicated by network 10. Network 10 represents a series of points or nodes of interconnected communication paths for receiving and sending network communications that propagate through telemetry feedback system 100. Network 10 offers a communicative interface between nodes, and may be configured as any local area network (LAN), virtual local area network (VLAN), wide area network (WAN) such as the Internet, wireless local area network (WLAN), metropolitan area network (MAN), Intranet, Extranet, virtual private network (VPN), any other appropriate architecture or system that facilitates communications in a network environment, or any suitable combination thereof. Network 10 can use any suitable technologies for communication including wireless (e.g., 3G/4G/5G/nG network, WiFi, Institute of Electrical and Electronics Engineers (IEEE) Std 802.11™-2012, published Mar. 29, 2012, WiMax, IEEE Std 802.16™-2012, published Aug. 17, 2012, Radio-frequency Identification (RFID), Near Field Communication (NFC), Bluetooth™, etc.) and/or wired (e.g., Ethernet, etc.) communication. Generally, any suitable means of communication may be used such as electric, sound, light, infrared, and/or radio (e.g., WiFi, Bluetooth or NFC).

Network traffic (also referred to herein as ‘network communications’ and ‘communications’), can be inclusive of packets, frames, signals, data, objects, etc., and can be sent and received in telemetry feedback system 100 according to any suitable communication messaging protocols. Suitable communication messaging protocols can include a multi-layered scheme such as Open Systems Interconnection (OSI) model, or any derivations or variants thereof (e.g., Transmission Control Protocol/Internet Protocol (TCP/IP), user datagram protocol/IP (UDP/IP)). The term ‘data’ as used herein, refers to any type of binary, numeric, voice, video, textual, photographic, or script data, or any type of source or object code, or any other suitable information in any appropriate format that may be communicated from one point to another in computing systems (e.g., endpoints, servers, computing systems, computing devices, etc.) and/or networks. Additionally, messages, requests, responses, replies, queries, etc. are forms of network traffic.

Server 40 can be provisioned in any suitable network environment capable of network access (e.g., via network 10) to endpoints 20(1)-20(N). For example, server 40 could be provisioned in a local area network with endpoints 20(1)-20(N) and one or more endpoints 20(1)-20(N) could be capable of accessing the server network 10. In another example, server 40 could be provisioned in a cloud network and accessed by endpoints 20(1)-20(N) provisioned in one or more other networks (e.g., LAN, MAN, CAN, etc.).

A server, such as server 40, is a network element, which is meant to encompass routers, switches, gateways, bridges, load balancers, firewalls, inline service nodes, proxies, proprietary appliance, servers, processors, or modules (any of which may include physical hardware or a virtual implementation on physical hardware) or any other suitable device, component, element, or object operable to exchange information in a network environment. This network element may include any suitable hardware, software, firmware, components, modules, interfaces, or objects that facilitate the operations thereof. Some network elements may include virtual machines adapted to virtualize execution of a particular operating system. Additionally, network elements may be inclusive of appropriate algorithms and communication protocols that allow for the effective exchange of data or information.

An endpoint, such as endpoints 20(1)-20(N), is intended to represent any type of computing system that can execute software programs and that is capable of initiating network communications in a network. Endpoints can include, but are not limited to, mobile devices, laptops, workstations, desktops, tablets, gaming systems, smartphones, infotainment systems, embedded controllers, smart appliances, global positioning systems (GPS), data mules, servers, appliances (any of which may include physical hardware or a virtual implementation on physical hardware), or any other device, component, or element capable of initiating voice, audio, video, media, or data exchanges within a network such as network 110. At least some endpoints may also be inclusive of a suitable interface to a human user (e.g., display screen, etc.) and input devices (e.g., keyboard, mouse, trackball, touchscreen, etc.) to enable a human user to interact with the endpoints.

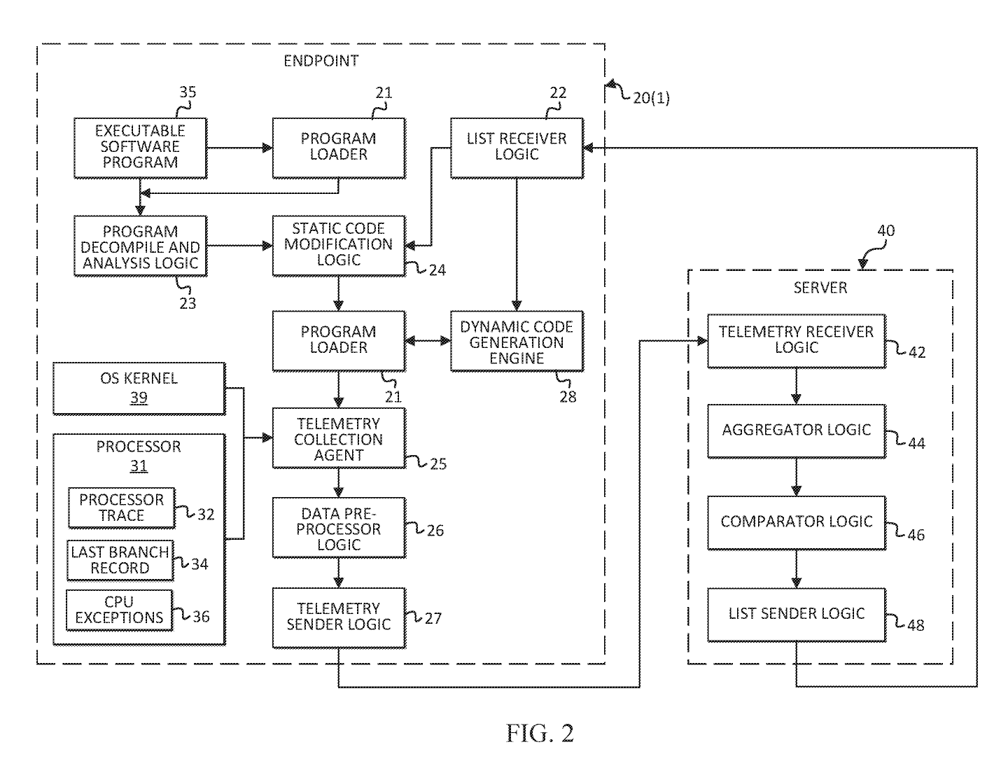

Turning to FIG. 2, FIG. 2 is a simplified block diagram illustrating one possible set of interactions associated with some components of telemetry feedback system 100. An executable software program 35 may be provided in endpoint 20(1). As used herein, an ‘executable software program’ is intended to mean a software program that has been compiled (e.g., converted, generated, translated, transformed, etc.) from a higher-level programming language into machine language (also referred to herein as ‘object code’ or ‘binary code’), which can be understood and executed by a computing system such as endpoints 20(1)-20(N). Program loader 21 may be used for embodiments in which code modifications (e.g., ENDBRANCH instruction injections) are made in compiled legacy programs on disk or otherwise at rest. Examples of program loader 21 include, but are not limited to an operating system (OS) or docker loader of portable executable (PE) files or software images.

Program decompile and analysis logic 23 decompiles object code of a software program to analyze operation codes (opcodes) in the object code. Opcodes are instructions (e.g., JUMP, CALL, RET, INT, etc.) in binary format that tell a processor which operation to perform. Program decompile and analysis logic 23 can operate on program images that are found on disk (e.g., object code such as executable software program 35 at rest) or that are loaded into memory but not yet executing (e.g., object code such as executable software program 35 loaded into memory by program loader 21).

In one example, decompilation involves transforming object code into decompiled code, which can be some higher-level code (e.g., assembler, source, etc.) of the software program. In other examples, decompiling may not transform the object code into higher-level code, but it analyzes the object code in its binary format to identify opcodes and find branch points. In this example the decompiled code includes the object code with identified opcodes. Decompiled code can be analyzed to find branch points. A branch point is intended to mean a location (e.g., an address, an index, etc.) of an indirect branch instruction (e.g., RET, CALL or various JUMP instructions used in ROP, COP, JOP exploits) within the object code or higher-level code of a software program. Thus, program decompile and analysis logic 23 can search the decompiled code for all occurrences of indirect branch instructions including, but not necessarily limited to, ROP, COP, and JOP instructions.

Static code modification logic 24 can add (e.g., inject, insert, put in, etc.) instructions in the decompiled code (e.g., object code with identified opcodes, higher-level code) to validate each indirect branch identified by program decompile and analysis logic 23. The decompiled code can be provided from the output of program decompile and analysis logic 23. In an embodiment using Code-flow Enforcement Technology, the instruction to be added to validate indirect branches can be an ENDBRANCH instruction that is inserted after each identified indirect branch point. The ENDBRANCH instruction indicates that the location has been validated so that when the indirect branch instruction is executed, a CET state machine does not generate an event.

In some scenarios, a list that indicates additional code modifications to be made to the program may be provided to static code modification logic 24 from list receiver logic 22. List receiver logic 22 may receive the list from server 40. The list may specify locations in the object code of the software program to add or remove an instruction, such as ENDBRANCH. In an embodiment, the specified locations may be in the form of object code locations, which are virtual memory addresses in software that are normalized to be comparable across multiple endpoints 20(1)-20(N). In some scenarios where the source code is available, the object code locations may be converted into source code locations with the help of compiler/linker-generated symbols (e.g., table of locations associated with program source code). The list may be generated by server 40 based on telemetry data received from other endpoints executing the same software program and/or telemetry data received from the current endpoint executing the same software program at a previous time. In some scenarios, the list could be used to supplement the analysis by program decompile and analysis logic 23. In other scenarios, the list could be used to replace the analysis by program decompile and analysis logic 23.

Once static code changes have been made to the decompiled code of a program, the modified object code may be stored if execution has not been initiated. In other scenarios, the modified object code may be loaded into memory by program loader 21, for example, if the object code was already loaded in memory prior to being decompiled, analyzed and modified. In some scenarios, such as when the decompiled code is in the form of a higher-level code, the decompiled code may be recompiled in order to produce the modified object code.

Dynamic code generation engine 28 can be provisioned in endpoint 20(1) to enable real-time dynamic modification of currently executing object code of a software program. For example, assume executable software program 35 has been loaded by program loader 21 and is currently executing on endpoint 20(1). Dynamic code generation engine 28 can receive a list of one or more object code modifications (e.g., additions or removals of ENDBRANCH instructions) for the currently executing object code. In at least one embodiment, dynamic code generation engine 28 may use binary translation or binary code rewriting to modify sequences of instructions in the object code that is being executed. Thus, the concepts disclosed herein include operating on compile-generated software programs to improve compiler logic via finding incorrect and/or missing validations (e.g., ENDBRANCH instructions).

Dynamic code generation engine 28 may stop or pause the execution of at least a portion of the object code in order to add or remove instructions indicated in the list. In at least one embodiment, the executing object code may be paused on a per memory page basis. If code modifications are specified in the list for a particular memory page (e.g., ENDBRANCH is to be added or removed in the memory page), then that memory page can be rendered nonexecutable until the change is made. For example, a virtual machine manager of endpoint 20(1) could make any page that is visible to the operating system or program of a guest virtual machine on the endpoint non-executable. When execution of that page is initiated, the execution control exits from the virtual machine into the VMM. The VMM can ensure that no logical processor executes any instructions from that memory page until the modifications have been completed. In an embodiment, binary translation may be used to translate the object code in the memory page to target code, modify the target code based on the list, and translate the modified target code back into the object code. Once the code changes are made, the VMM can make the memory page executable again and resume the guest VM. After a memory page has been dynamically modified, it may be loaded back into memory by program loader 21.

Telemetry collection agent 25 gathers telemetry data from one or more sources, where the telemetry data is related to object code executing on endpoint 20(1). As used herein, ‘telemetry data’ is intended to mean data related to the code flow of executing object code of a software program. In particular, telemetry data related to a particular software program can be gathered or collected during the execution of the object code of the software program and can include instruction pointer locations that are potentially relevant for validating (or removing the validation of) indirect branch points. In one embodiment, the validation of a branch point can be the insertion, after the branch point, of a particular instruction (e.g., ENDBRANCH) of the instruction set architecture. The removal of validation of a branch point can be the removal of a particular instruction (e.g., ENDBRANCH) located after the branch point. After a decompiled executable software program (either at rest or loaded in memory) is modified by static code modification logic 24, the modified object code may be recompiled (if needed), stored and executed. In another example, after an executing program (or relevant memory pages of the executing program) is paused in real-time and dynamically modified by dynamic code generation engine 28, execution of the modified program (or modified memory pages) may be resumed.

Telemetry data of the executing program may be gathered from the one or more sources of telemetry data. At least some telemetry data is provided by hardware, such as processor 31. One source of telemetry data includes a processor trace mechanism 32. Certain hardware processors include a processor trace (IPT) mechanism, such as 4^{th} Generation Intel® Core™ processors, made by Intel Corporation of Santa Clara, Calif. Processor trace mechanism 32 can generate packets that indicate what happens as a program is running on a processor. The processor can generate a stream of information that is delivered separately from the operations of the executing program. The packets containing the stream of information are referred to as ‘processor trace’. These packets can include transfer of instruction pointer (TIP) packets, which each indicate a location in the code where a branch occurred.

Another source of telemetry data can include a CPU last branch record (LBR) 34. LBR 34 provides a stack indicating where control flow has been transitioning within the code flow of a process. The process can be paused or stopped and the last LBR can be obtained. The last LBR can provide a history record of where all the branches have occurred in that program. This information can be harvested over time. Another source of telemetry data can include information related to any central processing unit (CPU) exceptions 36 that occur during execution of a program.

An operating system kernel 39 can also provide information to telemetry collection agent 25. This information can identify modules that are loaded in the processor address space and reveal the code in the modules. A module can be composed of a block of code that can be invoked to implement a particular functionality. The code of the modules can be examined to determine, for example, whether a branch point is the beginning of a function, whether the branch point is dynamically allocated code with some generic code, or whether the branch point is a return point from an existing function.

Data pre-processor logic 26 can apply various operations to packets from telemetry collection agent 25. For example, data pre-processor logic 26 can include, but is not limited to, removing duplications, normalizing addresses into comparable relative ones, applying filters of known exclusions and previously reported data, and compressing data. Data pre-processor logic 26 can filter against a static database to mark data that is already a known branch point (or entry point) and possibly annotate the data before sending it to server 40 via telemetry sender logic 27. The static database may have been created based on an analysis of the program when it was decompiled by program decompile and analysis logic 23. In at least one embodiment, the data pre-processor can optionally also serve as an updater of filters, de-duplicators, normalizers, etc.

Telemetry sender logic 27 receives pre-processed telemetry data from data pre-processor logic 26 and can send the pre-processed telemetry data to server 40. Telemetry receiver logic 42 of server 40 can receive the telemetry data of endpoint 20(1) in addition to receiving other pre-processed telemetry data from other endpoints in the network executing the same program. In at least one embodiment, the telemetry data may be sent using batch processing, where the telemetry data is not sent until a particular time occurs, a particular time interval passes (e.g., every minute, every hour, etc.), or a particular event occurs (e.g., program finishes executing, request is received for data, etc.). Additionally, the telemetry data may be prioritized (e.g. by importance) and such telemetry subsets may be sent separately in real time via synchronous streams and/or postponed for asynchronous transmission in batches.

Aggregator logic 44 in server 40 can aggregate the received telemetry data pertaining to the same software program (e.g., same hash on disk) received from different endpoints or from the same or different endpoints at different points in time. Aggregator logic 44 may also evaluate the telemetry data against policies. In at least one embodiment, aggregator logic 44 can create a memory map of a process that represents the execution of the program. The memory map could include, for example, how the modules are arranged in memory. Certain information may already be available to aggregator logic 44 such as file version and identifications of libraries associated with the software program (e.g., different libraries depending on the machine platform type such as Windows machine or a Linux machine).

Comparator logic 46 can compare branch points of a program that are observed via the various telemetry data sources (e.g., LBR, IPT, CET exceptions) between multiple (or all) executions of the program. This comparison can be performed using the memory map and can allow a determination of which ENDBRANCH instructions are correct (i.e., do not cause exceptions). Such a comparison may be desirable to due to the possibility that an ENDBRANCH instruction could be incorrectly inserted in a program (e.g., due to a bug in program decompile and analysis logic 23). The comparison can also allow a determination of which branch instructions should potentially be validated (e.g., observed code transfers without ENDBRANCH instructions). In at least one embodiment, branch points may be validated by adding an ENDBRANCH instruction after each branch instruction in the code where no validation instruction, such as ENDBRANCH, is present.

The comparisons, the memory map, and other contextual information can be used to determine which portions of the object code to observe during execution (if any) and which portions of the object code can be validated (e.g., by rewriting branch points with an ENDBRANCH instruction). For example, branch instructions in the object code that are validated with an ENDBRANCH instruction can be allowed to continue by a CET state machine when the program is executing. For branch instructions in the object code that are not validated by inserting an ENDBRANCH instruction, or branch instructions in the code where validation is removed by removing an ENDBRANCH instruction, an exception can be generated. The code generating the exception may be allowed to continue, but can be observed and monitored (e.g., IPT, LBR, etc.) based on the exceptions that are generated.

In one example scenario, a legacy software program can be enforced to be isolated across its components. If telemetry data indicates a particular sub-module or library of a program is executed, and if it is known from telemetry data that this legacy software program, when correctly executed, executes within this sub-module or library and then returns back normally and does not execute any other library in a nested manner, then certain rules could be configured based on this knowledge. The rules could require that, upon the invocation of the sub-module or library, an event could occur via the telemetry feedback system. The endpoint could switch the locations where ENDBRANCH has been inserted or could switch the memory pages that are being executed for that library such that any indirect branch that leaves the context of that sub-module could be observable by the telemetry feedback system 100 and could cause an exception. Thus, branch instructions that occur within the program can be restricted in a configurable manner.

A list can be generated that specifies particular object code of a program that is to be modified (e.g., list of incorrect or missing ENDBRANCH instructions). The list may also specify particular object code of the program for which correct validation is to be removed. In at least one embodiment, for validations, the list may include one or more addresses that specify locations within the object code where an ENDBRANCH instruction is to be inserted. For removing validations, the list may include one or more addresses that specify locations within the object code where an ENDBRANCH instruction is to be removed. If the ENDBRANCH instruction was associated with a branch instruction, then the removal of the ENDBRANCH instruction can enable an exception to be generated so that the code flow can be observed based on the exception. In at least one embodiment, when an ENDBRANCH instruction is removed, it may be replaced by a no-operation (NOP) instruction or something similar. It should be noted that in at least some embodiments, server 40 may have access to a repository of source code, object code (e.g., portable executable (PE) images, dynamic link library (DLL) images), program symbols, etc. to perform appropriate comparisons and to generate the list. In some cases, server 40 may include decompiler logic to enable determining the modifications to be made based on a higher-level code (e.g., source code, assembler) of the software program rather than, or in addition to, the object code.

List sender logic 48 of server 40 can send the list to endpoint 20(1). This list may be provided during the execution of the program on endpoint 20(1), so that the program can be dynamically updated by dynamic code generation engine 28. In other scenarios, the list may be provided to endpoint 20(1) when the program is not executing. In this scenario, the program may be updated by program decompile and analysis logic 23 and code modification logic 24, where the object code of the software program is obtained either from rest on a disk or after the object code is loaded in memory but prior to its execution. Additionally, list sender logic 48 may also send the list to one or more other endpoints in telemetry feedback system 100. These endpoints may use the list to update the object code stored on those endpoints or loaded in memory prior to execution or during execution on those endpoints.

In some instances, the list may be tailored to a particular endpoint. For example, the list may be tailored based on the particular installed software program on an endpoint. In a specific example, endpoint 20(1) may provide information that is sufficient to uniquely identify installed software or recently executed software to server 40. The information may include, but is not necessarily limited to, one or more of program name, vendor, fingerprint, hash, etc. of the installed or recently executed software. Server 40 can trim its full list to include only software relevant for each endpoint, to avoid transmitting irrelevant parts.

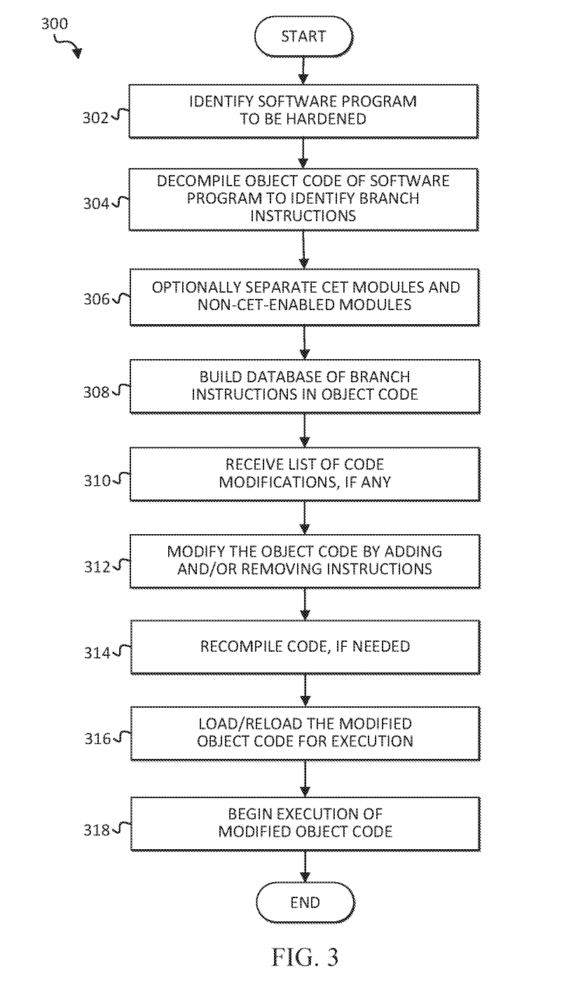

Turning to FIGS. 3-7, various flowcharts illustrate possible operations associated with one or more embodiments of a telemetry feedback system disclosed herein. In FIG. 3, a flow 300 may be associated with one or more sets of operations. An endpoint (e.g., endpoints 20(1)-20(N)) may comprise means such as one or more processors (e.g., 31), for performing the operations. In one example, at least some operations shown in flow 300 may be performed by one or more of program decompile and analysis logic 23, list receiver logic 22, static code modification logic 24, and program loader 21. Flow 300 may be performed to harden code of object code (e.g., executable software program 35) at rest (e.g., stored on a disk of endpoint 20(1) or loaded into memory but not yet executing).

At 302, an endpoint identifies a software program to be hardened. Identifying which software programs are to be evaluated and monitored may be configurable in at least one embodiment. A user, such as an Information Technology (IT) administrator, may select all programs residing on the endpoints of the telemetry feedback system or a subset of programs residing on the endpoints. The selections may be configured by one or more policies for the endpoints in the system. In other embodiments, the selections of programs to be evaluated and monitored may be based on one or more default policies or other pre-defined policies. At 302, the software program may be identified on disk or in memory of the endpoint based on user selection or other applicable policies.

At 304, object code of the software program can be decompiled to identify branch instructions. Destinations of the branch instructions may also be determined. Optionally, the decompiled code can be evaluated at 306, to identify any CET-enabled modules and any legacy modules that do not contain validated branch points. This evaluation indicates whether the branch instructions in the modules are validated (e.g., with ENDBRANCH instructions). At 308, the endpoint can statically determine whether the function entry points (or branch points) are located in the decompiled code or libraries that the program imports. The endpoint can build a database of these potential branch points (or entry points) in the program and its libraries.

In at least some scenarios, at 310, the endpoint can receive a list of one or more code modifications to be made to the decompiled code. The list can be generated by the server based on telemetry data received from other endpoints (and possibly the receiving endpoint if the software program had been previously executed on the receiving endpoint). In other scenarios, a list may not have been generated. For example, if the software program has not been executed on other endpoints or the receiving endpoint, then no telemetry data would have been reported and a list of code modifications may not have been generated.

If a list of one or more code modifications is received by the endpoint at 312, the decompiled code can be modified by adding and/or removing instructions at specified locations in the decompiled code according to the list. Additionally, any other code modifications (e.g., additional ENDBRANCH instructions missing at branch points) that were determined to be needed based on an analysis of the decompiled code may also be performed. Once the code modifications are completed, at 314, the modified code can be recompiled if needed into a modified or new object code. Recompiling may be needed, for example, when the decompiled code is in the form of a higher-level code such as source code or assembler. In some scenarios, the modified object code can be stored back to disk and the flow can end. For example, if the original object code was identified on disk for hardening, then the resulting modified object code may be stored back to disk.

In other scenarios, however, at 316, the modified object code may be loaded for execution. For example, if the original object code was on disk or otherwise at rest, then the resulting modified object code may be loaded into memory for execution. In another example, if the original object code was loaded in memory prior to execution beginning when it was identified for hardening, then the resulting modified object code may be reloaded to memory for execution. After the modified object code is reloaded in memory, at 318, the execution of the modified object code may begin.

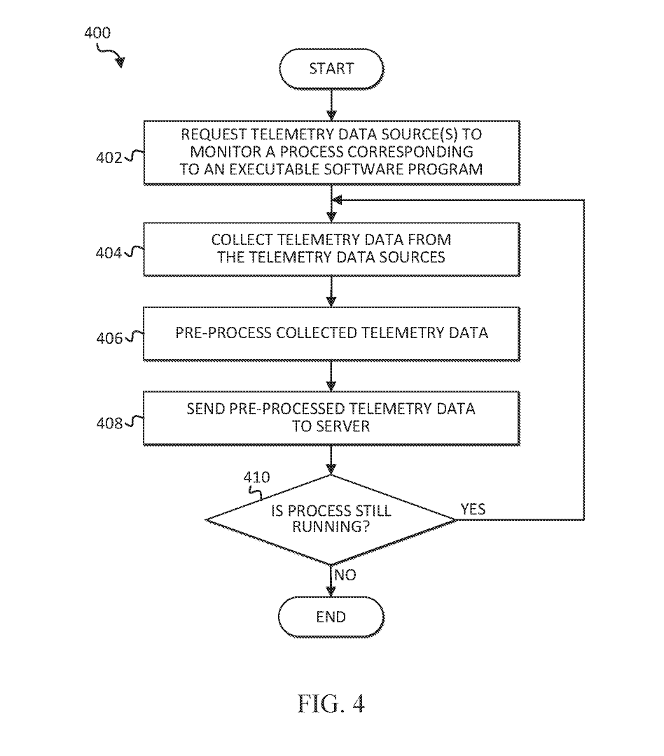

In FIG. 4, a flow 400 may be associated with one or more sets of operations. An endpoint (e.g., endpoints 20(1)-20(N)) may comprise means such as one or more processors (e.g., 31), for performing the operations. In one example, at least some operations shown in flow 400 may be performed by one or more of telemetry collection agent 25, data pre-processor logic 26, and telemetry sender logic 27. Flow 400 may be performed to collect telemetry data related to a process, where the process is an instance of object code (e.g., executable software program 35) executing on an endpoint.

Some telemetry data is generated automatically by a processor as a result of a process running on an endpoint. For example, CET records an exception when an indirect branch (ROP, COP, JOP, etc.) does not land on an ENDBRANCH instruction. Other types of telemetry data sources may generate telemetry data based on a request or enabling instruction. For example, a CPU last branch record (LBR) function can be selectively enabled for particular software programs (e.g., same hash on multiple endpoints), endpoints, and/or times. A processor trace function can also be selectively enabled. The selective enablement of these telemetry data sources may be temporary for a ‘learning mode’ and may be disabled or otherwise turned off (e.g., on some endpoints locally or globally, for some software programs, etc.) when sufficient coverage is achieved. Accordingly, in some scenarios, flow 400 can include a request at 402, to enable one or more telemetry data sources (e.g., IPT, LBR, etc.) to monitor a process instantiated when an executable software program is executed.

At 404, telemetry data is collected from one or more telemetry data sources. At least some of the telemetry data can be associated with unexcepted code flows and can provide knowledge about code-reuse (ROP, COP, JOP) threats or attacks in the field. Telemetry data sources can include, but are not necessarily limited to, IPT, LBR, CPU, exceptions, etc. The kernel of the processor can provide information about which modules are loaded in the processor address space and what the code looks like. IPT can provide addresses of locations in the code indicating where branching occurred. This information can be provided regardless of whether an ENDBRANCH instruction is present after an indirect branch instruction.

Some telemetry data may be derived from CPU exceptions that are recorded when an indirect branch is not followed by an ENDBRANCH instruction. This can provide valuable information regarding locations in the code that are targets of an indirect branch. If the locations are validated, an ENDBRANCH instruction can be added (e.g., statically at 312 or dynamically) to prevent further exceptions from being generated and consuming valuable resources. The execution of the code may then silently flow without an exception to the location targeted by the branch instruction.

In some scenarios, however, CPU exceptions may be forced for a branch instruction where it is desirable to observe the execution of the program flowing through a particular application programming interface (APIs) or other function. For example, it may be desirable to observe the flow of execution of a critical or sensitive API that is known to be targeted by malware. In this scenario, when an ENDBRANCH instruction is dynamically removed (e.g., statically at 312 or dynamically) from an indirect branch instruction in the code, the processor is enabled to record exceptions when the indirect branch occurs, and the location of the branch instruction can be silently reported. The telemetry data can indicate when the targeted location is invoked for example, by generating a CET event based on a missing ENDBRANCH instruction. This telemetry data can be collected at 404, via telemetry collection agent 25 and the process can be allowed to continue. The dynamic removal or addition of ENDBRANCH instructions can be intentional or random based on particular needs when monitoring an executing software program.

At 406, the collected telemetry data can be pre-processed before sending it to the server. In some scenarios, significant amounts of telemetry data can be collected. Sending all the data to a server may result in unnecessary use of bandwidth and resources in the system. Pre-processing can be used to identify relevant and new telemetry data to be reported to the server and to improve efficiency when communicating and using the data. Pre-processing can include, but is not limited to, any one or more of removing duplications, normalizing addresses into comparable relative ones, applying filters of known exclusions and previously reported data, and compressing data. In addition, the telemetry data can be filtered against a static database (e.g., database created at 308) to mark data that is already a known branch point (or entry point) and possibly annotate the data. In one example, telemetry data that is reported to the server may include only information derived from new branches of code that had not been previously executed and revealed by the collection of telemetry data.

At 408, the pre-processed telemetry data can be sent to the server. Regarding the pre-processing that is performed at 406, randomizing, throttling, filtering, normalizing and/or compressing telemetry data on endpoints can help reduce bandwidth requirements for telemetry data transmission. The timing of transmitting telemetry data can vary based on implementation, configuration, and particular needs. In one example, telemetry data can be transmitted using batch processing periodically, at any desirable time interval (e.g., once per day, once per hour, etc.). The desired time interval may be human-configurable. In another example, telemetry data can be transmitted based on the amount of data accumulated during a particular process. In yet another example, telemetry data could be transmitted after a process has completed.

At 410, a determination can be made as to whether the process is still running (i.e., whether the software program is still executing). When telemetry data is sent to the server while the process is still running, then additional telemetry data related to the same process may be subsequently collected, pre-processed and sent to the server. Accordingly, at 410, if a determination is made that the process is still running, then flow can pass back to 404 to begin such collection, pre-processing and sending. If the process is determined to not be running, then flow 400 can end. It should be noted that flow 400 presupposes that all telemetry data is collected before pre-processing the data. However, in some embodiments, collecting and pre-processing telemetry data may occur multiple times before the final pre-processed telemetry data is sent to the server.

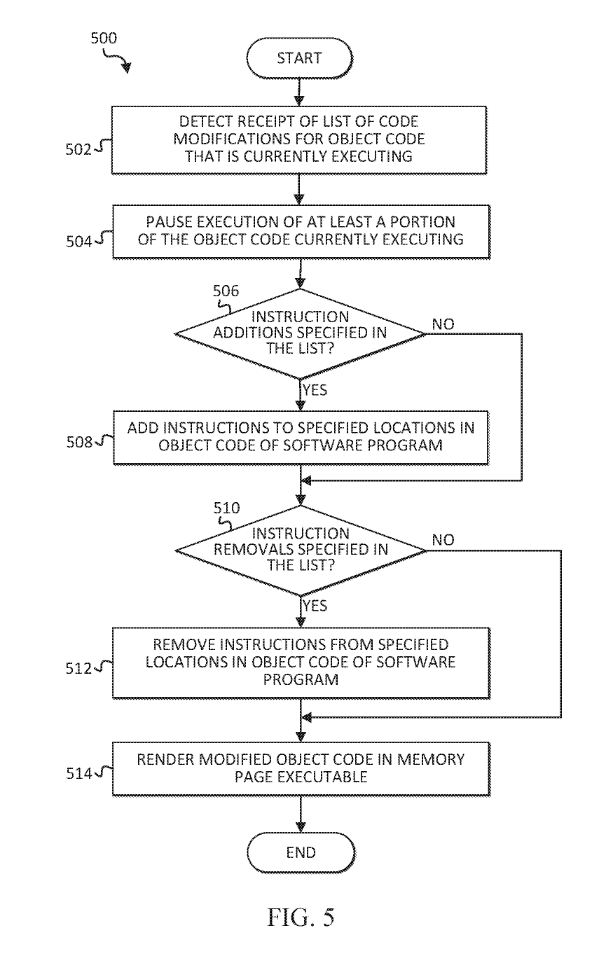

In FIG. 5, a flow 500 may be associated with one or more sets of operations. An endpoint (e.g., endpoints 20(1)-20(N)) may comprise means such as one or more processors (e.g., 31), for performing the operations. In one example, at least some operations shown in flow 500 may be performed by one or more of list receiver logic 22 and dynamic code generation engine 28. Flow 500 may be performed to dynamically modify object code (e.g., executable software program 35) while it is executing to add instructions that validate one or more indirect branches (e.g., RET, CALL, JUMP, INT, etc.) in the object code and/or to remove instructions that validate one or more other indirect branches in the object code.

At 502, an endpoint can detect receipt of a list of modifications for the object code that is currently executing on the endpoint. The list can contain indications of missing validations of indirect branches, incorrect validations of indirect branches, and/or correct validations that are to be selectively removed. More specifically, in at least one embodiment, the list can identify branch instructions by locations (e.g., addresses with offsets) within the code, where the branch instructions are indirect branches (e.g., ROP, COP, JOP, etc.) to APIs or other functions. For each branch instruction, the list can indicate a particular modification that should be made. If a branch instruction is currently not validated (e.g., an ENDBRANCH instruction does not follow the branch instruction), the list may indicate the branch instruction should be validated. If a branch instruction is currently validated (e.g., an ENDBRANCH instruction directly follows the branch instruction), the list may indicate the validation is to be removed from the branch point. In one example, a branch instruction can be validated by adding an ENDBRANCH instruction immediately following the branch instruction, and validation can be removed from a branch instruction by removing an ENDBRANCH instruction immediately following the branch instruction.

At 504, the processor can pause execution of at least a portion of the object code that is currently executing. In an embodiment, the executing object code may be paused on a per memory page basis based on the code modifications specified in the list. If a modification is specified in the list for a particular memory page, then that memory page can be rendered non-executable to enable the modification. In at least one embodiment, binary translation can be used to translate the memory page to modify the object code (e.g., add or remove ENDBRANCH instructions) and replace the original memory page with the translated memory page.

At 506, if it is determined that one or more instruction additions are specified in the list to validate branch instructions in the object code, then at 508, the one or more instructions can be added to the code. If no instruction additions are specified in the list, then no instructions are added to the code. At 510, if it is determined that one or more instruction removals are specified in the list to remove validation of branch instructions in the code, then at 512, the one or more instructions are removed from the code. In at least one embodiment, when an ENDBRANCH instruction is removed, it may be replaced by a no-operation (NOP) instruction or something similar. If no instruction removals are specified in the list, then no instructions are removed from the code. Once the modification (or translation) is complete, the modified object code can be rendered executable again and loaded back into the memory page. Execution of the object code can flow to the modified memory page, if appropriate.

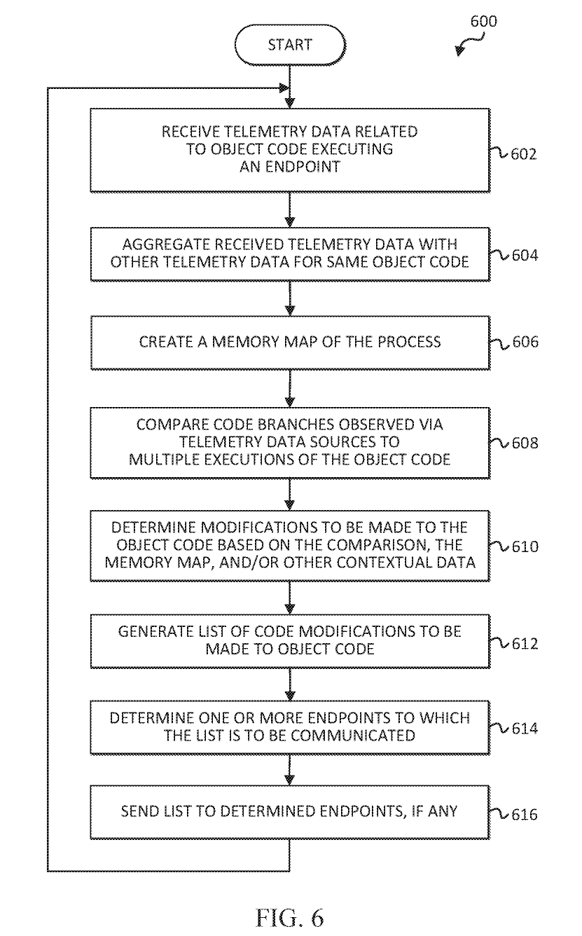

In FIG. 6, a flow 600 may be associated with one or more sets of operations. A backend server (e.g., server 40) may comprise means such as one or more processors (e.g., 41), for performing the operations. In one example, at least some operations shown in flow 600 may be performed by one or more of telemetry receiver logic 42, aggregator logic 44, comparator logic 46, and list sender logic 48. Flow 600 may be performed to evaluate telemetry data related to object code (e.g., executable software program 35) currently executing on an endpoint and generate a list of code modifications, if needed, to validate certain portions of the object code and/or to remove validations of certain other portions of the object code.

At 602, the server receives telemetry data related to object code executing on an endpoint. The telemetry data may be collected from the endpoint during the execution (or subsequent to the execution) of the object code. The server may also have previously received (or may be concurrently receiving) telemetry data related to the same object code (e.g., same hash), which is executing on one or more other endpoints. At 604, the telemetry data received from the endpoint is aggregated with other telemetry data related to the execution of the same object code on one or more other endpoints or on the same endpoint. Policies may also be evaluated and at 606, a memory map can be created of a process representing an execution of the object code and how components of the process are arranged in memory. The memory map can be created based on the aggregated telemetry data and policies. In addition, the server may have a priori information related to the object code such as file version, libraries, and code. For example, a priori information can include identification of libraries based on the type of machine (e.g., Windows-based machine, Linux-based machine, etc.).

At 608, the code branches of the object code that were observed via telemetry data sources (e.g., LBR, IPT, CET exceptions, etc.) during multiple executions of the object code on multiple endpoints can be compared. The comparison enables determinations related to object code that is correctly validated (e.g., ENDBRANCH instructions following branch instructions) and object code that is not validated (e.g., ENDBRANCH instructions not following branch instructions) or not correctly validated (e.g., ENDBRANCH instructions that should not have been added to the code). The server may at this point attempt to detect anomalies in the telemetry data pertaining to execution of ROP exploits in certain endpoint(s). For example, a simple threshold crowdsourcing method may be applied (e.g., if less than X % of endpoints report a branch then it may be an anomaly related to a ROP exploit) or more sophisticated methods based on temporal properties and learning correct branching for a short period of time after software release (e.g., recently released software is very unlikely to be exploited as ROP/COP/JOP exploits have to be tailored for specific software). Combining these methods as well as any other suitable heuristics to flag anomalies is also possible. Such anomalies may be reported as potential live field ROP/COP/JOP exploitations.

At 610, the comparisons, the memory map, and possibly other contextual information can be used to determine code modifications to be made to the object code. More specifically, in at least one embodiment, determinations can be made as to which portions of the object code, if any, are to be observed during execution by not validating those portions or removing validations of those portions (e.g., by not rewriting the object code with ENDBRANCH instructions following branch instructions, or by rewriting the object code to remove ENDBRANCH instructions following branch instructions) and which portions of the code are to be validated (e.g., by rewriting object code with ENDBRANCH instructions following branch instructions).

At 612, a list can be generated that specifies the code modifications to be made to the object code. In at least one embodiment, locations of the code can be specified and indications of whether to add an ENDBRANCH instruction or remove an existing ENDBRANCH instruction at each of those locations can also be indicated. At 614, a determination can be made as to which one or more endpoints in the telemetry feedback system the list is to be communicated. For example, in some configurations, the list may only be provided to endpoints that are currently executing the object code. In other configurations, the list may be provided to each endpoint in which the object code is installed. It will be apparent that numerous other configurations may be made based on particular needs and implementations. At 616, the list may be sent to each of the determined endpoints, if any.

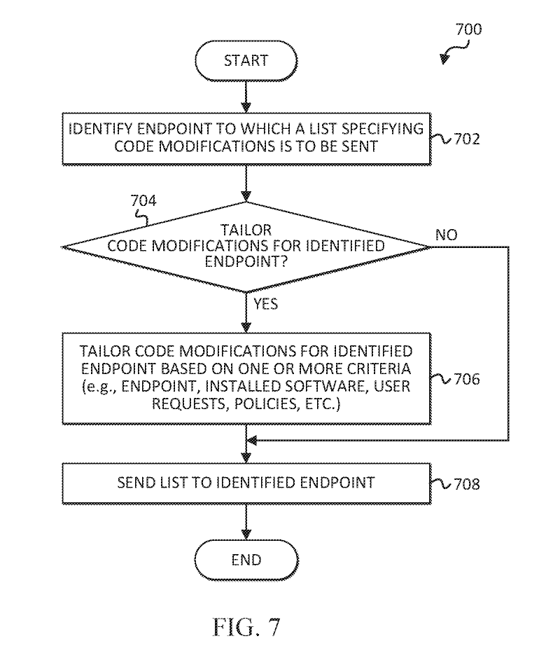

In FIG. 7, a flow 700 may be associated with one or more sets of operations. A backend server (e.g., server 40) may comprise means such as one or more processors (e.g., 41), for performing the operations. In one example, at least some operations shown in flow 700 may be performed by one or more of aggregator logic 44, comparator logic 46, and list sender logic 48. Flow 700 may be performed tailor the list of code modifications to particular endpoints receiving the list.

At 702, the server identifies an endpoint to which a list specifying code modifications is to be sent. At 704, a determination is made as to whether the code modifications should be tailored for the identified endpoint. If the determination is that the code modifications should not be tailored, then the list is sent without being tailored, at 708, to the identified endpoint. If the determination, at 704, is that the code modifications are to be tailored for the identified endpoint, then at 706, the code modifications can be tailored based on one or more criteria. Criteria for tailoring the code modifications can include, but are not limited to an identification of the identified endpoint (e.g., type, platform, etc.), installed software programs on the identified endpoint, user requests, and/or policies. Once the code modifications are tailored (e.g., ENDBRANCH instruction additions and removals are added or deleted from the list of code modifications), then at 708, the list can be sent to the identified endpoint.

It should be noted that, while the description of telemetry feedback system 100 has specifically referenced ENDBRANCH instructions to validate branching invocations, such systems may be configured with other types of instructions that could also, or alternatively, be used to validate branch invocations. A special opcode(s) similar in functionality to ENDBRANCH may be defined (statically or dynamically) via microcode modification in general-purpose CPU architectures or coded into field programmable gate array (FPGA) logic. In addition, other instructions could be configured dynamically, in real-time, based on the telemetry to control other facets of the program execution. Thus, the specific description in this specification is not intended to be limiting, but rather, is intended to cover various other configurations and implementations related to analyzing and controlling program execution to increase efficiency and/or to dynamically enable observation of selected portions of code during the execution of a software program.

FIG. 8 is a simplified block diagram of a security-enabled computing system 800 for providing data flow correctness in an executing software program. Security-enabled computing system 800 is configured with software programs 802A, 802B, and 802C, an operating system 810, a processor 820, and a memory element 830. Operating system 810 can include a memory manager 812 and a program loader 814. A page table 832 and memory pages 834 can be allocated (and deallocated) in memory element 830 by memory manager 812 when a software program (e.g., software programs 802A, 802B or 802C) is loaded and executed. Memory element 830 may also have stored therein executable instructions for providing operating system 810. Memory element can also have stored therein software portions, if any, of a metadata engine 822, a checkpoint engine 824, and an exception handler 826. Metadata engine 822, checkpoint engine 824, and exception handler 826 are coupled to processor 820 and can include hardware to perform the functions thereof.

For purposes of illustrating certain example techniques of a security-enabled computing system, it is important to understand the activities that may be occurring in such systems. The following foundational information may be viewed as a basis from which the present disclosure may be properly explained.

Data leaks from computer systems present a persistent and significant issue for individuals, enterprises, and other entities. Data leaks can occur due to unauthorized code execution attacks and range from old buffer overflows resulting in shellcode injection and execution, to newer code-reuse attacks based on return oriented programming (ROP) exploits. In addition to ROP exploits, other code-reuse attacks include call oriented programming (COP) and jump oriented programming (JOP) exploits. Software bugs may also result in data leaks.

Code reuse exploits are particularly difficult to mitigate. In one example, a code reuse exploit gains control over execution of a program by leveraging a logic flaw in the program, where the logic flaw is used to reach memory that has been corrupted. Page tables in memory contain function pointers that are read by logic during runtime to determine which functions to execute and where execution flow advances in a program. If a logic flaw exists in how the memory is managed for different objects, an attacker can use the logic flaw to corrupt the function pointer tables or other data structures in memory to direct the flow of execution to the attacker's desired location in the program. Thus, ROP/COP/JOP code reuse can be maliciously achieved.

Mitigating techniques are generally based on recognizing and blocking code that is either injected or executed via code reuse to prevent unauthorized code execution attacks. These techniques, however, tend to fail eventually when attackers develop new techniques. They also benefit from having full control over the attack logic and targeted software. Some efforts have been made to address code reuse exploits by tracking code flow, such as Control-Flow Enforcement Technology (CET). These efforts, however, do not address legacy programs that have already been compiled.

Data taint tracking is a method of data flow tracking for software. Data taint tracking is based on binary translation to track memory regions to enforce constraints on certain activities. This approach can be performance expensive due, at least in part, to the need to translate each instruction to enable the application of data taint tracking. Currently, there is no reliable and efficient data flow tracking in software at run-time. A more generic approach is needed, which does not rely solely on blocking code injection or code reuse, to guarantee data flow correctness.

Other memory corruption flaws can be leveraged by attackers to perform a use-after-free attack. Generally, a use-after-free attack is the attempt to access memory after it has been freed, which can potentially result in an abnormal end to the program or the execution of unintended code. In certain programming languages (e.g., C, C++), a program manually allocates and deallocates memory to store its data. After memory is freed (i.e., deallocated), the memory can be used by other programs to store other data. In these programming languages, however, even after memory has been deallocated, the original program can still read from and write to the memory.

To combat use-after-free attacks, memory permissions may be applied in hardware through page tables. Page tables can be created by an operating system, or virtual machine manager (VMM) in virtualized systems, and can be interpreted by a central processing unit (CPU) or processor. The CPU can allow the operating system (or VMM) perform access control in order to isolate processes so that the allocated memory for each process is used by that process and not by other processes.

An extended page table (EPT) sub-page permissions architecture allows an operating system or VMM to reduce the granularity at which memory access controls can be applied. Memory pages are physical pages of memory that can be allocated for programs. Using EPT sub-page permissions architecture, a memory page could be subdivided into multiple sub-page regions. Accordingly, static permissions (e.g., nonwritable/writeable, nonreadable/readable, etc.) can be applied per sub-page region. These permissions can be applied by storing metadata that indicates the static permissions to be applied. Metadata associated with a particular sub-page region can be stored in a sub-page region that is adjacent to the particular sub-page region containing the data. The metadata is fetched at the same time an access to the associated adjacent sub-page region occurs, and the metadata is used to apply access control perimeters on the memory access.

The protocol of applying sub-page memory permissions via metadata currently occurs in software. Thus, use-after-free attacks can be achieved by exploiting logic flaws in the software. Such flaws can occur when a program allocates memory, stores information in the allocated memory, passes a pointer to the allocated physical memory space to another part of the program, and then frees the memory. In this scenario, malware could overwrite the same block of memory with its desired contents. If the other part of the original program that still has the pointer accesses the overwritten memory, then the original program may execute malicious code. Accordingly, an approach to address use-after-free attacks, while maintaining the ability to apply permissions at a sub-page level is also needed.

Embodiments disclosed herein can resolve the aforementioned issues (and more) associated with execution flows of a software program in a computing system. Security-enabled computing system 800 efficiently analyzes and controls execution flows, including data flow and code flow, of software programs. The system generates expected metadata for an executing software program and places this verification metadata into memory sub-page regions associated with corresponding data structures. In at least one embodiment, this verification metadata is placed in random access memory (RAM) sub-pages. At runtime, the system determines whether the program is accessing code and data as expected according to the verification metadata. More particularly, hardware, such as metadata engine 822 and checkpoint engine 824, can obtain verification metadata, populate memory sub-pages, and set up checkpoints in the program. During runtime, when a checkpoint occurs in the program, an external handler is invoked to perform the verification based on the metadata. Additionally, verification metadata can be dynamically determined during execution and added (or updated) in appropriate sub-page regions allocated to the executing program.

Security-enabled computing system 800 provides several advantages including providing a performance-friendly method of monitoring software correctness. In addition, the system can reduce software bugs that are vulnerable to exploitation by malware. In security-enabled computing system 800, verification of execution flow compliance with expected behavior is supported by hardware exceptions based on accesses to sub-page regions or particular instructions such as ENDBRANCH triggers (or software interrupts or hardware breakpoints). The sub-page regions containing metadata are allocated in the same memory pages as the data that is accessed by the program. This ensures quick access when coupled with caching algorithm behavior and caching of sub-page permissions. Software bugs can be reduced due to better or deeper debugging and providing developers with a better view of code flows and data flows. Furthermore, the techniques described herein can provide processor functionality that may be added as a minor extension to proposed sub-page support.

Turning again to FIG. 8, security-enabled computing system 800 can provide analysis and control of execution flows, including both data flow and code flow. Before discussing potential operation flows associated with the architecture of FIG. 8, brief discussion is provided about some of the possible components and infrastructure that may be associated with security-enabled computing system 800.

Security-enabled computing system 800 can include any type of computing device capable of executing software programs including, but not limited to, workstations, terminals, laptops, desktops, tablets, gaming systems, mobile devices, smartphones, servers, firewalls, appliances (any of which may include physical hardware or a virtual implementation on physical hardware), or any other suitable device, component, element, or object operable to execute software programs. This computing system may include any suitable hardware, firmware, software, components, modules, interfaces, or objects that facilitate the operations thereof. Security-enabled computing systems may also be inclusive of appropriate algorithms, network interfaces, and communication protocols that allow for the effective exchange of data or information in a network environment. At least some security-enabled computing systems may also be inclusive of a suitable interface to a human user (e.g., display screen, etc.) and input devices (e.g., keyboard, mouse, trackball, touchscreen, etc.) to enable a human user to interact with the security-enabled computing system.

Operating system 810 of security-enabled computing system 800 is software that is provisioned to manage the hardware and software resources of the system. In particular, operating system 810 may be configured with program loader 814, which can load software programs (e.g., software programs 802A, 802B, and 802C) and any associated libraries into memory (e.g., memory element 830) and prepare them for execution. Programs and their libraries can be loaded into main storage, such as random access memory (RAM).

Operating system 810 can also include a memory manager 812 that controls and coordinates computer memory (e.g., memory element 830). Memory manager 812 can allocate or assign portions of memory to various running programs to ensure proper isolation of them. Memory manager 812 can involve components that physically store data such as, for example, RAM, memory caches, flash-based solid-state drives (SSDs), all of which may be represented by memory element 830. In particular, memory manager 812 can dynamically allocate memory pages, such as memory pages 834, for a particular program and can populate a page table, such as page table 832, with a mapping between the virtual and physical addresses of the allocated memory pages. When the program no longer needs the data in previously allocated memory pages, these pages can be freed (or deallocated) such that they become available for reassignment. A virtual address is also referred to herein as a ‘linear address’.

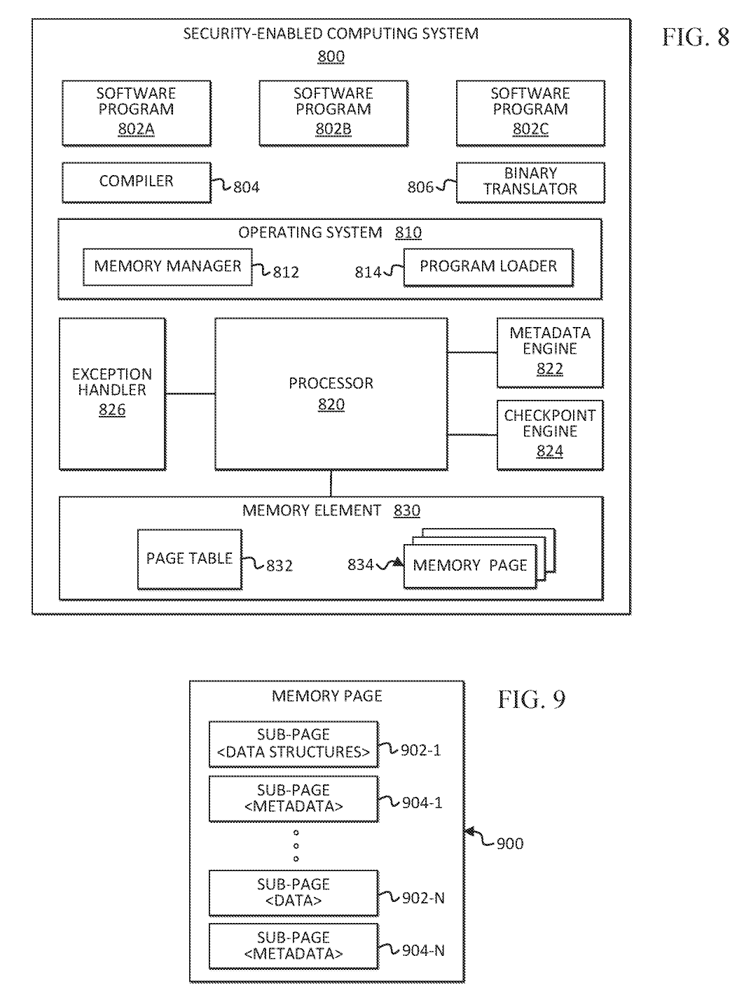

FIG. 9 illustrates additional details that may be associated with memory pages associated with embodiments disclosed herein. FIG. 9 is a simplified block diagram illustrating an example memory page 900, which is a representative example of one memory page of memory pages 834 of security-enabled computing system 800. Memory page 900 may be allocated by an operating system (e.g., memory manager 812 of OS 810) or by a VMM or hypervisor in a virtualized security-enabled computing system. The memory page may be subdivided into multiple sub-page regions 902(1)-902(N) and 904(1)-904(N) of any suitable size based on the architecture and particular needs of the implementation. Each sub-page region allocated for data structures of a program (e.g., for code or other data) may be referred to herein as a ‘primary sub-page region.’ Each primary sub-page region can be associated with one or more associated sub-page regions allocated for metadata that is related to contents of the primary sub-page region. These associated sub-page regions are also referred to herein as ‘metadata sub-page regions.’

For ease of illustration, FIG. 9 illustrates single metadata sub-page regions that are allocated for each primary sub-page region containing program data structures. A metadata sub-page region can include code flow and/or data flow verification information related to a primary sub-page region containing program data structures. Although FIG. 9 illustrates single metadata sub-page regions for each primary sub-page region, in other embodiments, two or more metadata sub-page regions may be associated with a primary sub-page region. The size of memory page 900 may be defined by the architecture in which memory page 900 is allocated.

A metadata sub-page region may be allocated anywhere within a memory page containing its associated primary sub-page region. For example, a metadata sub-page region may be allocated directly before or after (or multiple metadata sub-page regions may be allocated directly before and after) the associated primary sub-page region. In at least one embodiment, it may be efficient to allocate a metadata sub-page region adjacent to (directly before or directly after) its associated primary sub-page region. In other embodiments, however, a metadata sub-page region may not be adjacent to its associated primary sub-page region. The association between a metadata sub-page region and a primary sub-page region can be established and maintained using any suitable technique. For example if a write access to a read-only memory object (as set in the page table permissions) occurs, then an exception handler may look up a table of “page address”-“metadata location” pairs. Such a table can maintain the association of a primary sub-page region and its one or more associated metadata sub-page region. The table can also enable identification of a primary sub-page region's associated metadata sub-page region. In another example, a trap from a checkpoint may initiate a similar lookup in a local non-adjacent metadata store. The store could have some relation to the access of data causing the trap and thus, the association can be maintained.

For purposes of explanation, an example implementation of memory pages that may be allocated by security-enabled computing system 800 is now described. Some architectures allow 4 Kilobyte (KB) regions to be allocated for a memory page. By way of example, a 4 KB memory page could be subdivided into 32 sub-page regions each having 128 byte chunks of memory. Primary sub-page region 902(1) could be used by the executing program to store data structures of the program. The adjacent metadata sub-page region 904(1) could be reserved for use by the architecture for storing metadata associated with the chunk of memory defined by primary sub-page region 902(1). In the example of a 4 KB memory page subdivided into 32 128 B chunks of memory, memory page 900 could include primary sub-page regions 902(1)-902(N) corresponding to metadata sub-page regions 904(1)-904(N), respectively, where N=16. It should be noted that these memory allocations are provided for illustration purposes only. In other implementations, memory pages may be bigger or smaller in size and sub-page regions of a memory page may be subdivided into any suitable manner based on provisioning and implementation needs, for example. Furthermore, as previously described herein, in some scenarios, a primary sub-page regions may be associated with two or more metadata sub-page regions, rather than having a one-to-one correspondence as illustrated in FIG. 9.

With reference to components in FIG. 8, in an embodiment, one or more of metadata engine 822, checkpoint engine 824, and exception handler 826 can include executable instructions stored on a non-transitory medium operable to perform a computer-implemented method according to this disclosure. The executable instructions can include hardware instructions, which may include logic at least partially implemented in hardware in conjunction with or in addition to software-programmable instructions. At an appropriate time, such as upon booting security-enabled computing system 800 or upon a command from operating system 810 or a user via a user interface (not shown), processor 820 may retrieve a copy of the software-programmable instructions (e.g., from storage such as a hard drive) and load them into appropriate portions (e.g., RAM) of memory element 830.

In another example, one or more of metadata engine 822, checkpoint engine 824, and exception handler 826 are implemented as hardware instructions. The hardware instructions may include logic that performs the operations at hardware speeds. It should be noted that ‘non-transitory medium’ is intended to include hardware instructions stored on a non-transitory medium (e.g., processor) that are executed as part of the processor logic, rather than being loaded into memory.

In at least some embodiments, metadata engine 822 and checkpoint engine 824 may be invoked by software, such as memory manager 812. For example, when memory manager 812 is invoked to allocate memory for a data structure needed by a program for execution or during execution, the memory can be allocated and a pointer to the allocated memory can be provided to one or both of metadata engine 822 and checkpoint engine 824. In a specific implementation that is intended to be non-limiting, a memory allocation library (e.g., malloc) of memory manager 812 may be modified to automatically invoke hardware instructions (e.g., metadata engine 822, checkpoint engine 824) to provision the metadata when memory allocation is requested for a program. A free library of memory manager 812 may be modified to automatically invoke hardware instructions (e.g., metadata engine 822) to update the metadata when its associated memory that contains program data is freed.

In at least one embodiment, when metadata engine 822 is invoked, it can determine verification metadata for a primary sub-page region and populate the appropriate sub-page(s) with the verification metadata. Metadata related to expected execution flows can be static or dynamic in nature and can be generated in several ways. A compiler, either on security-enabled computing system 800 or on separate device (e.g., server of software provider/builder), can generate metadata based on compiling a software program. In another example, a binary translator 806 or application programming hooks (API) can generate metadata from the program binary code during execution or prior to execution when the program is loaded for execution but not yet executing its instructions. Binary translator 806 may be implemented in various ways, for example as a CPU code convertor activated in advance (before code execution) or as a just-in-time (JIT) code convertor for the entire program or any suitable portions of it.

Certain static metadata associated with primary sub-page regions containing program data can be leveraged to prevent RAM swapping. RAM swapping occurs when two (or more) linear addresses associated with different processes are mapped to the same physical address. This can occur with processes that are running in the same processor address space. One of the processes could potentially use its linear address, termed an ‘alias address,’ to corrupt the memory (intentionally or inadvertently) to which both linear addresses point.

To prevent such RAM swapping, a linear address of a process could be stored as metadata in a metadata sub-page region. For example, when page table 832 is updated with the linear address that is used to access a primary sub-page region containing program data, metadata engine 822 could be invoked to store the linear address as metadata in a metadata sub-page region allocated in the same memory page and associated with the primary sub-page region. A verification check by exception handler 826 could be performed on the metadata (i.e., the linear address) to ensure that there are no alias address accesses to that memory block and that only one linear address is being used to read and/or write to that memory block.

In at least some embodiments, verification metadata may be generated for dynamically allocated memory structures to verify data flow and code flow. In one example, the metadata can be based on the memory allocations. Compiler 804 (or a compiler separate from security-enabled system 800) or binary translator 806 may inject code into a program to populate sub-pages with verification metadata by, for example, invoking metadata engine 822 to update the appropriate one or more metadata sub-page regions in RAM. The code can be injected after a RAM allocation (e.g., heap or stack allocation calls, malloc API calls, etc.) in the program. In at least one embodiment, the code injections should precede the program code that uses these dynamic memory structures. Unlike static EPT permissions, this metadata may be dynamically generated based on actual program behavior. Moreover, this metadata may be based on compiler output and, consequently, may provide more granularity related to verifying memory accesses. Accordingly, this dynamically-generated metadata can help prevent use-after-free attacks.

Once the verification metadata is stored in the metadata sub-page region, then the processor can begin checking those accesses to ensure that if a particular block of memory is written to or read from, that the particular block of memory is in an allocated state (i.e., the memory has not been deallocated). If the block of memory is in a deallocated (or freed) state, however, then read and write accesses can be blocked based on the failure of the verification process performed by exception handler 826. Also, when the block of memory is deallocated by the program, then the metadata can be updated to indicate that the memory is deallocated (free). Thus, reading and writing to the memory when the memory is deallocated can be prevented.

In at least some embodiments, exception handler 826 may be invoked by checkpoints in the program that trigger verification that the code flow and data flow are correct as the program is executing. The program may be paused to allow the exception handler to perform the verification and then resumed if the verification succeeds. In some implementations, an execution may resume even if the verification fails, as a notification of the failure or other logging mechanism is used to track verification failures. Verifying the code flow and data flow can include determining that verification metadata (i.e., expected metadata or a derivation thereof) of a program corresponds to actual metadata of the program during execution.

Setting checkpoints may be a compiler option in at least some embodiments and a particular program can include any number of checkpoints in various locations in the program (e.g., after every access to controlled memory structure, after subroutine calls, after all/some external API calls, in each critical section of software after N instructions, etc.). In addition, exceptions may trigger dynamic verification. Instead of program checkpoints, a verification may be implemented as an independent system task (e.g. performed periodically, time-scheduled, randomly or in response to selected events by the operating system or hypervisor).

In an example of enabled permission checks in a program, a memory page (or a sub-page region or cache line) is accessed to read or write data or to execute an instruction, which can cause a memory access permission check. The memory access permission check may be a sub-page permission check. Sub-page permissions can be used to indicate a particular region of memory (e.g., sub-page, cache line, etc.) is nonwritable, for example. Any attempted write access could cause an access control check, which could be used by operating system 810 (or a VMM in a virtualized system) to check the access and then either emulate it or allow it.

In another example, when a particular instruction or software interrupt is detected, in conjunction with sub-page permissions being enabled, verification is triggered. An example of such an instruction can include a CET instruction such as ENDBRANCH, as previously described herein. This instruction may be inserted into the code by a compiler (e.g., compiler 804, a compiler of the software program provider, a compiler in the cloud, etc.) or by a binary translator (e.g., binary translator 806, etc.). A software interrupt can include a special instruction in the instruction set or an exceptional condition in the processor itself. One example of a software interrupt is an INT 3 instruction, which generates a special one byte opcode (0xCC) that is intended for calling a debug exception handler.

In yet another example, a checkpoint may be set based on hardware-supported breakpoints. A hardware-supported breakpoint could include an instruction or data that is intentionally configured in a processor to cause a program to stop or pause during execution. The breakpoint could trigger verification of the program. In the embodiments describing checkpoints (and breakpoints), exception handler 826 can perform a verification check in hardware based on the verification process being triggered.

In a further example, upon the occurrence of a checkpoint event, operating system 810 (or the VMM in a virtualized system) could switch the active page table view (which may be an extended page table) in which the currently executing program is operating. Switching the EPT view could temporarily turn off sub-page permissions on that particular region of memory so that the access can be allowed to complete. Thus, if a verification trigger occurs, the system can change the EPT view (or active EPT structure) such that sub-page permissions are temporarily removed from the page associated with the verification trigger, complete the read or write to that sub-page region, and then reactivate the sub-page permissions on that page. Thus, a checkpoint is effectively created, which can be checked by operating system 810 (or the VMM for a virtualized system).

In an embodiment, exception handler 826 may be invoked by checkpoints that trigger verification, as previously described herein. These checkpoints can include hardware instructions (e.g., hardware-supported breakpoint, ENDBRANCH, etc.) and software instructions (e.g., software interrupt, sub-page permission checks, etc.). The verification process can include comparisons of an extended instruction pointer (EIP) register (i.e., address of next instruction to be executed), values on stack, last branch record (LBR), processor trace, and CPU registers used for accessing the data with the verification metadata in order to determine if actual execution metadata corresponds to the metadata of expected correct program behavior (e.g., correct logic flow of the program). At least some of these values can be compared with metadata stored in metadata sub-page regions to determine whether certain memory is allocated or deallocated. For example, if the linear address used by the CPU to access/modify data memory corresponds to the expected linear address listed in the metadata as well as the action (e.g., read or write), then the verification succeeds (i.e., actual metadata corresponds to verification metadata in metadata sub-page region(s)).

Another verification that could be performed by the exception handler 826 includes an integrity check comparison for data reads. A metadata sub-page region is generally at least as big as its associated primary sub-page region (e.g., 128B, 64B, etc.). Other types of metadata that may be stored in a metadata sub-page region include cryptographic information associated with the primary sub-page region. In one illustrative example, the hardware could use a key to apply a cryptographic algorithm to the contents of the primary sub-page region when it is allocated in order to derive a hash value from the contents. The hash value can be stored in the metadata sub-page region that is associated with the primary sub-page region. If a read is subsequently performed on the data block, then the hardware can perform an Integrity Check Value (ICV) check for the primary sub-page region before it returns data. In this scenario, if malicious action (software or hardware) corrupted the data, then because the malicious action would not be able to write to the sub-page region, the malicious action (or user) would not be capable of maliciously modifying the ICV. Therefore, the ICV verification would fail when an attempt is made to read the primary sub-page region. This can be an additional verification that may be performed independently or in conjunction with other verifications previously described herein. Metadata engine 822 could perform an update of the metadata (e.g., new values for a write operation) based on binary translation and/or instrumentation during runtime if the initial metadata verification is successful.

Exception handler 826 may also generate an event based on the verification process. For example, any anomalies identified in the code flow or data flow may be reported. In an embodiment, anomalies can be indicated if a mismatch is identified between what actually occurs during the program execution (e.g., from EIP register, values on stack, LBR, processor trace, CPU registers, etc.) compared to what is expected to occur (e.g., from metadata sub-page regions). A mismatch can be identified based on determining that the actual execution data does not correspond to metadata of expected correct program behavior. In this scenario, an event can be generated by, for example reporting or otherwise logging the anomalies. A report could be performed via a page-fault or EPT violation with a sub-page qualifier indicating the sub-page region that experienced the metadata mismatch. It should be noted that a determination as to whether actual execution data corresponds to expected program behavior could be based on any suitable analysis (e.g., actual metadata matching expected/verification metadata, actual metadata related to expected/verification metadata based on some defined criteria, etc.).

Embodiments disclosed herein can include various features. For example, a compiler (e.g., compiler 804, compiler of software provider/builder, compiler in the cloud, etc.) that compiles programs to be run in security-enabled computing system 800 may create expected metadata for the program that can be used at runtime by program loader 814 or by binary translator 806. To avoid tampering with and ensure integrity of metadata, the verification metadata may be digitally signed (e.g., by a software provider/builder) and provided with the corresponding software either in advance or downloaded dynamically before execution. A compiler option (e.g., compiler 804) may be implemented to put each data element (e.g., data structures in memory typically taking a contiguous portion of RAM) into a separate sub-page for tracking flows. Data elements can include, but are not limited to variables, arrays, lists, etc. Once these flows are proven correct during debugging, the software may be recompiled with data structures squeezed together. For dynamic memory allocations, similar on-the-fly data distribution to metadata sub-pages may be done.

In some embodiments, exception handler 826 may be provisioned inline, provisioned in a trusted execution environment (TEE) (e.g., Secure Guard Extensions (SGX), TrustZone, etc.), or provisioned as a special trusted kernel component. Also, in some embodiments, code portions generated by the compiler that populate sub-pages with verification metadata may be digitally signed and provisioned in a TEE (e.g., SGX, TrustZone, VMM, etc.) to prevent tampering attempts. Another feature of at least some embodiments includes special #pragma instructions that specify how a compiler should process its input. More specifically, #pragma instructions could be implemented to allow developers to specify which dynamic memory structures require runtime verification. Such specification can allow control and minimization of performance effects for frequent compiler's code inclusions to inject verification metadata for dynamic structures.

Metadata creators (e.g., binary translator 806, compiler 804, compiler of software provider/builder, etc.) and exception handler 826 may be provisioned based on particular needs and implementations. For example, a metadata creator and exception handler 826 may be provisioned as part of the software that loads software containers (e.g., Docker) or apps (e.g., Android™ Runtime (ART), any other Just-In-Time (JIT) compiler). In another example, a metadata creator and exception handler 826 may be provisioned as part of the software that executes scripts (e.g., JavaScript, Lua, Microsoft® Visual Basic® Scripting Edition (VBScript), etc.) or interprets bytecode (e.g., Java™, Dalvik, etc.).

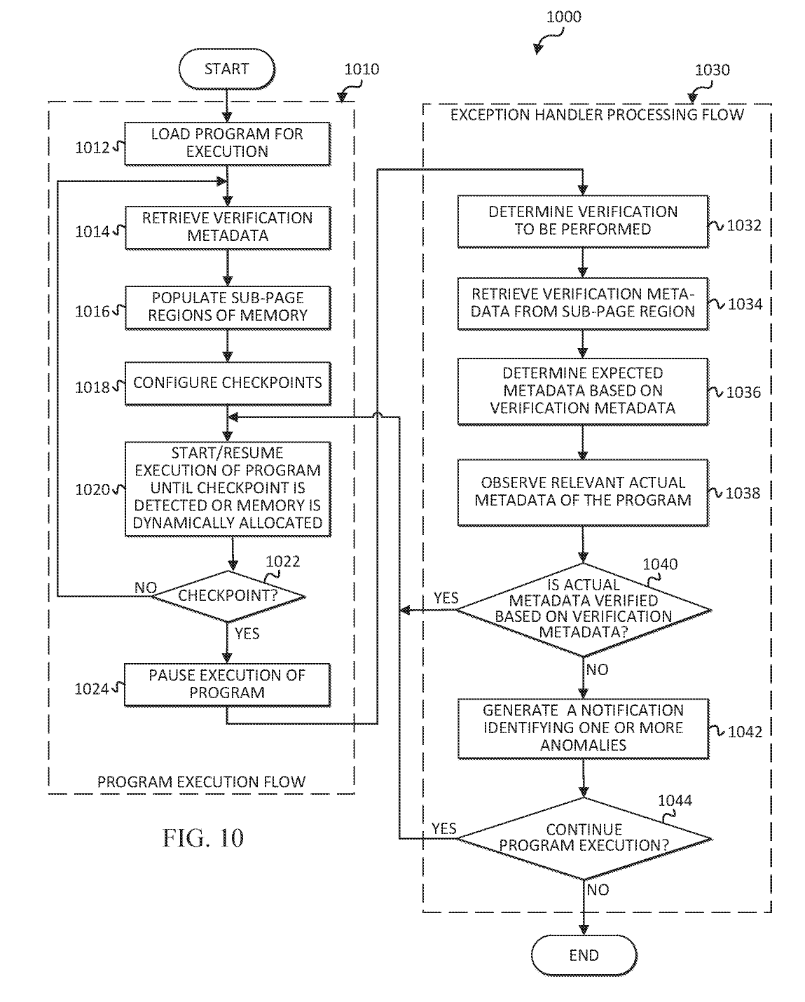

Turning to FIG. 10, FIG. 10 is a flowchart of a possible flow 1000 of operations that may be associated with embodiments of a system for analyzing and controlling execution flows as described herein. In at least one embodiment, one or more sets of operations correspond to activities of FIG. 10. Security-enabled computing system 800 or a portion thereof, may utilize the one or more sets of operations. Security-enabled computing system 800 may comprise means such as processor 820, for performing the operations. In an embodiment, a metadata engine (e.g., 822), a checkpoint engine (e.g., 824), and an exception handler (e.g., 826) each perform at least some operations of flow 1000. In an embodiment, flow 1000 includes operations occurring during a program execution flow 1010 and operations occurring during an exception handler processing flow 1030.

In an example, flow 1000 of FIG. 10 may begin when a program (e.g., software program 802A, 802B or 802C) is initiated for execution in security-enabled computing system 800. At 1012, the program is loaded for execution. In one example, program loader 814 loads the program. At 1014, verification metadata is retrieved. Verification metadata can include various types of metadata, which can be evaluated during execution of the program to dynamically verify that the actual code and data flows of the program correspond to the expected code and data flows indicated by the verification metadata.

In one example, if static sub-page regions of memory are to be allocated for the program, the program loader can invoke a memory manager such as memory manager 812 to allocate that memory. The memory manager can cause invocation of metadata engine 822, which can retrieve one or more backend policies that require checkpoints to be enforced on the static sub-page regions. Backend policies could be locally configured in security-enabled computing system 800 or remotely configured (e.g., in an enterprise network, by the software developer of the program, etc.). Accordingly, metadata engine 822 can implement the one or more policies for the appropriate sub-page regions such that a checkpoint is enforced each time (or a number of times based on the policy) the program attempts to access one of the sub-page regions.

In an embodiment, one or more policies can be implemented at 1016, by populating metadata sub-page regions. Each metadata sub-page region that is associated with a primary sub-page region containing data structures of the program can directly precede, directly follow, or both directly precede and directly follow its associated primary sub-page region. In some implementations, one or more of the metadata sub-page regions can be located in the same memory page as, but not directly adjacent to, their associated primary sub-page regions. An example of verification metadata that can be used to populate a metadata sub-page region or regions associated with a primary sub-page region is a linear address mapped to a physical address of the primary sub-page region. The linear address can prevent other programs from accessing the primary sub-page region with an alias address that is mapped to the same physical address. Another example of verification metadata includes a hash of the contents of a primary sub-page region. Yet another example of verification metadata includes identification of an operation to be performed that is associated with the primary sub-page region (e.g., read, write, etc.).

At 1018, checkpoints could be configured for each primary sub-page region that is to be verified. In one example, traditional sub-page permissions are configured to indicate that a primary sub-page region is or is not readable or writeable or both. An attempt to access the primary sub-page region (or cache line) to read, write, or execute an instruction can cause an access control check where the operating system or VMM can apply appropriate permissions, thus creating a checkpoint on how the memory is being used. In one example, a hardware-supported checkpoint could be used. The system, of course, may operate without setting any static checkpoints, instead using, for example, dynamic verifications periodically, on a time-scheduled basis, randomly or in response to selected events by the operating system or hypervisor.

In one example, the operating system (or VMM) could switch the active EPT view in order to temporarily turn off sub-page permissions for that sub-page so that access is allowed to complete. The sub-page permissions can be reactivated, thus creating a checkpoint that can be checked by the operating system or VMM.

In another example of configuring a checkpoint, special instructions (e.g., ENDBRANCH) or software interrupts can be added to the program code. If a relevant page has sub-page permissions enabled, this can cause the exception handler to be invoked so that the verification check is performed in hardware.

At 1020, execution of the program may begin. Execution can continue until a checkpoint associated with a particular primary sub-page region is detected or until additional memory is dynamically allocated for the program. It should be noted that other conditions may also cause the program to stop execution such as the program ending. If a checkpoint is detected as indicated at 1022, then execution of the program can be paused at 1024, and exception handler 826 may be invoked such that exception handler processing flow 1030 begins.

At 1032, the verification to be performed can be determined. For example, verification may be performed for static data or dynamic data. In this example, it can be assumed that no checkpoints have been configured for dynamic data yet, so a determination can be made that the verification is to be performed for static data. At 1034, verification metadata can be retrieved from the one or more metadata sub-page regions associated with the primary sub-page region related to the checkpoint event. When an access is attempted on the primary sub-page region, both the primary sub-page region being accessed and its associated one or more metadata sub-page regions are accessed.

At 1036, a determination can be made as to the expected code flow and data flow based on the retrieved verification metadata. For example, the metadata may include a linear address that is expected to be used to access the primary sub-page region associated with the metadata sub-page region. Thus, the linear address in the metadata can be determined to be the expected address used by an instruction to access the primary sub-page region. A type of operation (e.g., read, write, etc.) to be performed on the primary sub-page region may also be indicated in the verification metadata in the associated metadata sub-page region. In addition, a hash of one or more portions of the primary sub-page region may be provided in the verification metadata.

At 1038, actual metadata based on code flow and data flow of the executing program can be observed. Depending on the particular verification being performed, one or more of an EIP, values on stack, LBR, processor trace information, and CPU registers associated with the program may be observed. One or more of these values may be compared with the verification metadata at 1040 to determine whether the observed, actual flows correspond to the expected flows. If the actual metadata corresponds to the verification metadata, then the exception handler 826 can pass control back at 1020, to resume execution of the program. The results of verification (all passes and failures) may be logged to assist in debugging the software. In at least one embodiment, the results may be submitted as telemetry to a server as previously described herein.

If the observed code and data flows do not correspond to the expected code and data flows (e.g., a mismatch occurs) then at 1042, one or more identified anomalies may be reported. This can include logging the anomalies for debugging purposes and/or issuing a notification identifying the anomalies. The report could be performed via a page-fault or EPT violation with a sub-page qualifier indicating the data region that experienced the metadata mismatch. In at least one embodiment, these anomalies may also be submitted as telemetry to a server as previously described herein.

At 1044, a determination can be made as to whether execution of the program should continue after the verification fails. If the determination is not to continue execution of the program, then the program can end. However, if the determination is to continue execution of the program, then the exception handler 826 can pass control back at 1020, to resume execution of the program. Whether execution is to continue or not after a failed verification may be determined based on configurable policies.

With reference again to 1022, if a checkpoint is not detected, then memory has been dynamically allocated. For example, the compiler or the binary translator may have injected code into the program, where the injected code precedes program code that accesses a primary sub-page region, but is subsequent to the memory allocations (e.g., heap or stack calls, APIs).

In this scenario, flow passes back to 1014, where dynamic verification metadata is retrieved. In particular, metadata to be stored in a metadata sub-page region may indicate that its associated primary sub-page region is in an allocated state, and therefore, read and write accesses by the program to the primary sub-page region can be verified in exception handler processing 1030. At 1016, the metadata sub-page region associated with the primary sub-page region, for which memory was dynamically allocated, can be populated by the verification metadata. At 1018, a checkpoint can be configured so that read and write accesses to the primary sub-page region invoke exception handler 826 and verification is performed on the accesses. At 1020, execution of the program can resume until another checkpoint is detected or additional memory is dynamically allocated.

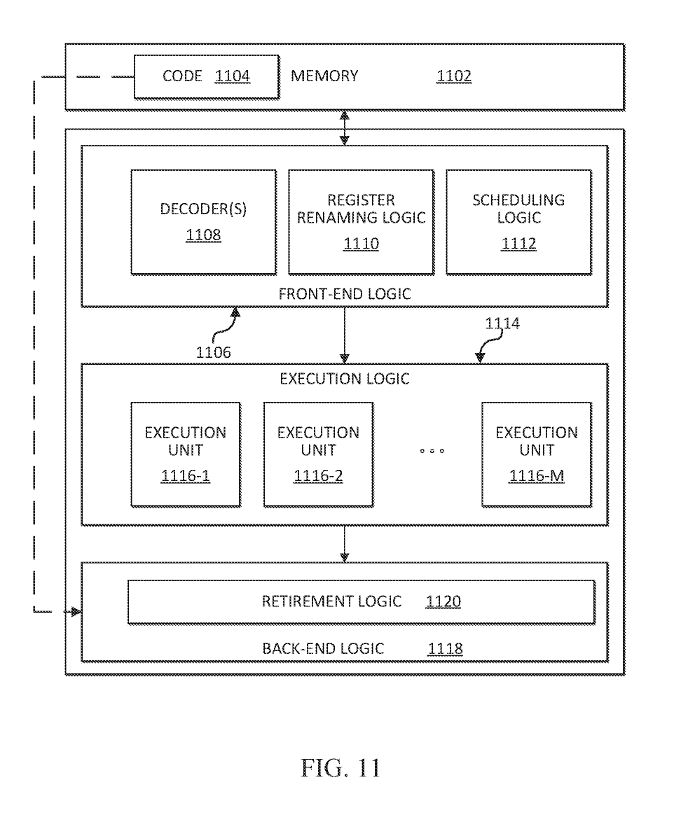

FIG. 11 is an example illustration of a processor according to an embodiment. Processor 1100 is one possible embodiment of processor 31 of endpoint 20(1), processor 41 of server 40, and/or processor 820 of security-enabled computing system 800. Processor 1100 may be any type of processor, such as a microprocessor, an embedded processor, a digital signal processor (DSP), a network processor, a multi-core processor, a single core processor, or other device to execute code. Although only one processor 1100 is illustrated in FIG. 11, a processing element may alternatively include more than one of processor 1100 illustrated in FIG. 11. Processor 1100 may be a single-threaded core or, for at least one embodiment, the processor 1100 may be multi-threaded in that it may include more than one hardware thread context (or “logical processor”) per core.

FIG. 11 also illustrates a memory 1102 coupled to processor 1100 in accordance with an embodiment. Memory 1102 is one embodiment of memory element 33 of endpoint 20(1), memory element 43 of server 40, and/or memory element 830 of security-enabled computing system 800. Memory 1102 may be any of a wide variety of memories (including various layers of memory hierarchy) as are known or otherwise available to those of skill in the art. Such memory elements can include, but are not limited to, random access memory (RAM), read only memory (ROM), logic blocks of a field programmable gate array (FPGA), erasable programmable read only memory (EPROM), and electrically erasable programmable ROM (EEPROM).

Code 1104, which may be one or more instructions to be executed by processor 1100, may be stored in memory 1102. Code 1104 can include instructions of various logic and components (e.g., list receiver logic 22, program decompile and analysis logic 23, code modification logic 24, telemetry collection agent 25, data pre-processor logic 26, telemetry sender logic 27, dynamic code generation engine 28, telemetry receiver logic 42, aggregator logic 44, comparator logic 46, list sender logic 48, software programs 802A-802C, compiler 804, binary translator 806, operating system 810, memory manager 812, program loader 814, metadata engine 822, checkpoint engine 824, exception handler 826, etc.) that may be stored in software, hardware, firmware, or any suitable combination thereof, or in any other internal or external component, device, element, or object where appropriate and based on particular needs. In one example, processor 1100 can follow a program sequence of instructions indicated by code 1104. Each instruction enters a front-end logic 1106 and is processed by one or more decoders 1108. The decoder may generate, as its output, a micro operation such as a fixed width micro operation in a predefined format, or may generate other instructions, microinstructions, or control signals that reflect the original code instruction. Front-end logic 1106 also includes register renaming logic 1110 and scheduling logic 1112, which generally allocate resources and queue the operation corresponding to the instruction for execution.

Processor 1100 can also include execution logic 1114 having a set of execution units 1116-1 through 1116-M. Some embodiments may include a number of execution units dedicated to specific functions or sets of functions. Other embodiments may include only one execution unit or one execution unit that can perform a particular function. Execution logic 1114 can perform the operations specified by code instructions.

After completion of execution of the operations specified by the code instructions, back-end logic 1118 can retire the instructions of code 1104. In one embodiment, processor 1100 allows out of order execution but requires in order retirement of instructions. Retirement logic 1120 may take a variety of known forms (e.g., re-order buffers or the like). In this manner, processor 1100 is transformed during execution of code 1104, at least in terms of the output generated by the decoder, hardware registers and tables utilized by register renaming logic 1110, and any registers (not shown) modified by execution logic 1114.

Although not shown in FIG. 11, a processing element may include other elements on a chip with processor 1100. For example, a processing element may include memory control logic along with processor 1100. The processing element may include I/O control logic and/or may include I/O control logic integrated with memory control logic. The processing element may also include one or more caches. In some embodiments, non-volatile memory (such as flash memory or fuses) may also be included on the chip with processor 1100.

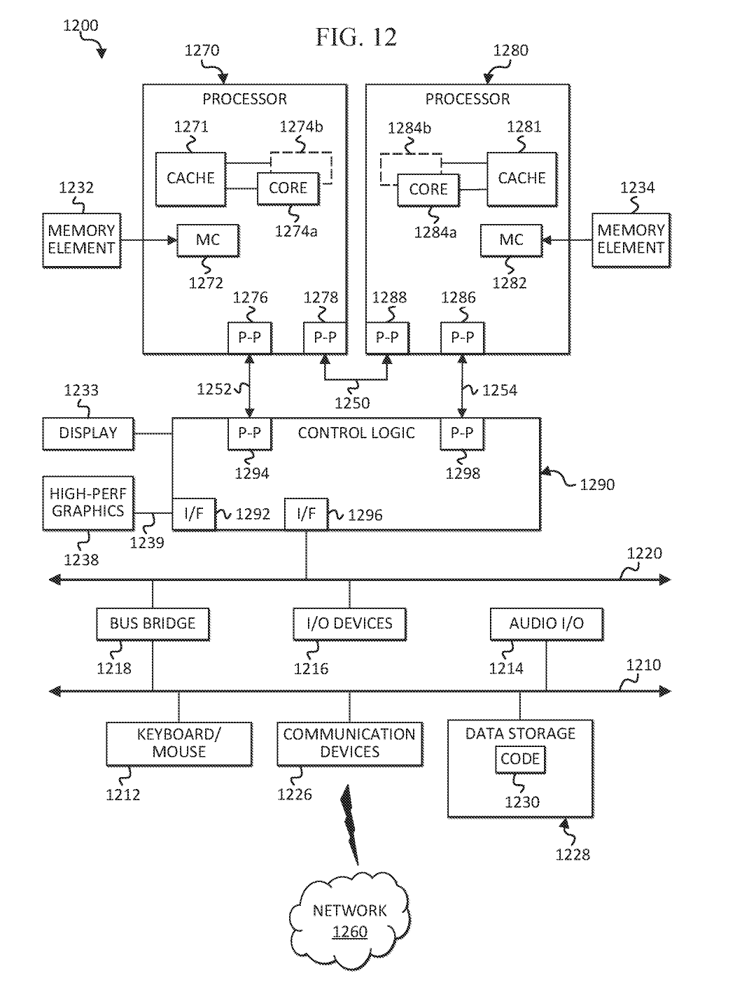

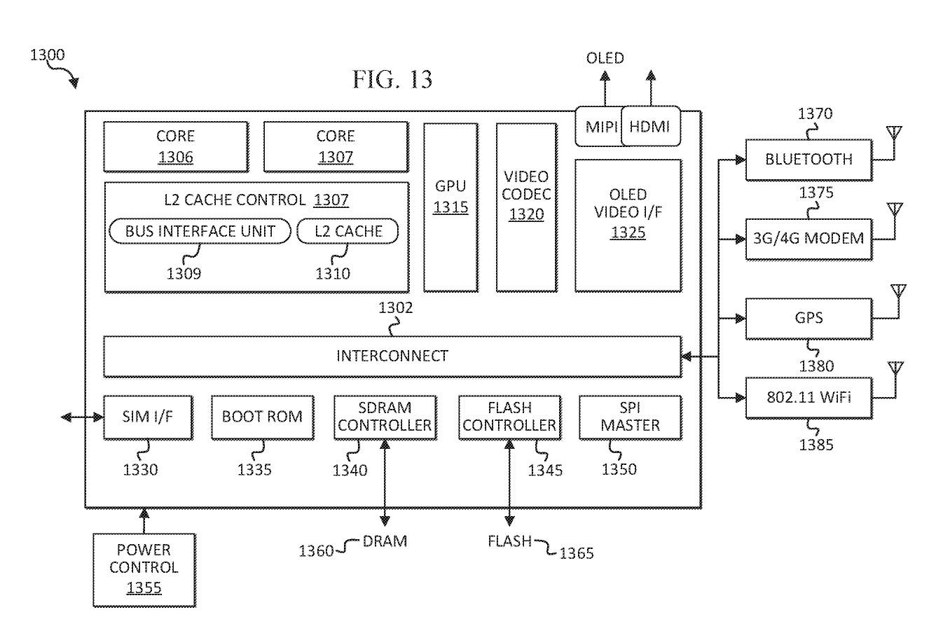

FIG. 12 illustrates one possible example of a computing system 1200 that is arranged in a point-to-point (PtP) configuration according to an embodiment. In particular, FIG. 12 shows a system where processors, memory, and input/output devices are interconnected by a number of point-to-point interfaces. In at least one embodiment, endpoints 20(1)-20(N), server 40 and/or security-enabled computing system 800, shown and described herein, may be configured in the same or similar manner as exemplary computing system 1200.

Processors 1270 and 1280 may also each include integrated memory controller logic (MC) 1272 and 1282 to communicate with memory elements 1232 and 1234. In alternative embodiments, memory controller logic 1272 and 1282 may be discrete logic separate from processors 1270 and 1280. Memory elements 1232 and/or 1234 may store various data to be used by processors 1270 and 1280 in achieving operations associated with analyzing and controlling code flow and/or data flow, as outlined herein.

Processors 1270 and 1280 may be any type of processor, such as those discussed with reference to processor 1100 of FIG. 11, and processors 31 and 41 of FIG. 1 and processor 820 of FIG. 8. Processors 1270 and 1280 may exchange data via a point-to-point (PtP) interface 1250 using point-to-point interface circuits 1278 and 1288, respectively. Processors 1270 and 1280 may each exchange data with a control logic 1290 via individual point-to-point interfaces 1252 and 1254 using point-to-point interface circuits 1276, 1286, 1294, and 1298. As shown herein, control logic is separated from processing elements 1270 and 1280. However, in an embodiment, control logic 1290 is integrated on the same chip as processing elements 1270 and 1280. Also, control logic 1290 may be partitioned differently with fewer or more integrated circuits. Additionally, control logic 1290 may also exchange data with a high-performance graphics circuit 1238 via a high-performance graphics interface 1239, using an interface circuit 1292, which could be a PtP interface circuit. In alternative embodiments, any or all of the PtP links illustrated in FIG. 12 could be implemented as a multi-drop bus rather than a PtP link. Control logic 1290 may also communicate with a display 1233 for displaying data that is viewable by a human user.

Control logic 1290 may be in communication with a bus 1220 via an interface circuit 1296. Bus 1220 may have one or more devices that communicate over it, such as a bus bridge 1218 and I/O devices 1216. Via a bus 1210, bus bridge 1218 may be in communication with other devices such as a keyboard/mouse 1212 (or other input devices such as a touch screen, trackball, joystick, etc.), communication devices 1226 (such as modems, network interface devices, or other types of communication devices that may communicate through a computer network 1260), audio I/O devices 1214, and/or a data storage device 1228. Data storage device 1228 may store code 1230, which may be executed by processors 1270 and/or 1280. In alternative embodiments, any portions of the bus architectures could be implemented with one or more PtP links.

The computing system depicted in FIG. 12 is a schematic illustration of an embodiment that may be utilized to implement various embodiments discussed herein. It will be appreciated that various components of the system depicted in FIG. 12 may be combined in a system-on-a-chip (SoC) architecture or in any other suitable configuration capable of achieving the telemetry and execution flow features, according to the various embodiments provided herein.

Turning to FIG. 13, FIG. 13 is a simplified block diagram associated with an example ARM ecosystem SOC 1300 of the present disclosure. At least one example implementation of the present disclosure can include the telemetry and execution flow features discussed herein and an ARM component. For example, in at least some embodiments, endpoints 20(1)-20(N), server 40 and/or security-enabled computing system 800, shown and described herein, could be configured in the same or similar manner ARM ecosystem SOC 1300. Further, the architecture can be part of any type of tablet, smartphone (inclusive of Android™ phones, iPhones™), iPad™, Google Nexus™, Microsoft Surface™, personal computer, server, video processing components, laptop computer (inclusive of any type of notebook), Ultrabook™ system, any type of touch-enabled input device, etc.

In this example of FIG. 13, ARM ecosystem SOC 1300 may include multiple cores 1306-1307, an L2 cache control 1308, a bus interface unit 1309, an L2 cache 1310, a graphics processing unit (GPU) 1315, an interconnect 1302, a video codec 1320, and an organic light emitting diode (OLED) I/F 1325, which may be associated with mobile industry processor interface (MIPI)/high-definition multimedia interface (HDMI) links that couple to an OLED display.

ARM ecosystem SOC 1300 may also include a subscriber identity module (SIM) I/F 1330, a boot read-only memory (ROM) 1335, a synchronous dynamic random access memory (SDRAM) controller 1340, a flash controller 1345, a serial peripheral interface (SPI) master 1350, a suitable power control 1355, a dynamic RAM (DRAM) 1360, and flash 1365. In addition, one or more example embodiments include one or more communication capabilities, interfaces, and features such as instances of Bluetooth™ 1370, a 3G modem 1375, a global positioning system (GPS) 1380, and an 802.11 Wi-Fi 1385.

In operation, the example of FIG. 13 can offer processing capabilities, along with relatively low power consumption to enable computing of various types (e.g., mobile computing, high-end digital home, servers, wireless infrastructure, etc.). In addition, such an architecture can enable any number of software applications (e.g., Android™, Adobe® Flash® Player, Java Platform Standard Edition (Java SE), JavaFX, Linux, Microsoft Windows Embedded, Symbian and Ubuntu, etc.). In at least one example embodiment, the core processor may implement an out-of-order superscalar pipeline with a coupled low-latency level-2 cache.

Regarding possible internal structures associated with endpoint 20(1), server 40, and security-enabled computing system 800, a processor is connected to a memory element, which represents one or more types of memory including volatile and/or nonvolatile memory elements for storing data and information, including instructions, logic, and/or code, to be used in the operations outlined herein. Endpoint 20(1), server 40, and security-enabled computing system 800 may keep data and information in any suitable memory element (e.g., static random access memory (SRAM), dynamic random access memory (DRAM), read-only memory (ROM), programmable ROM (PROM), erasable PROM (EPROM), electrically EPROM (EEPROM), a disk drive, a floppy disk, a compact disk ROM (CD-ROM), a digital versatile disk (DVD), flash memory, a magneto-optical disk, an application specific integrated circuit (ASIC), or other types of nonvolatile machine-readable media that are capable of storing data and information), software, hardware, firmware, or in any other suitable component, device, element, or object where appropriate and based on particular needs. Any of the memory items discussed herein (e.g., memory elements 33, 43, 830) should be construed as being encompassed within the broad term ‘memory element.’ Moreover, the information being used, tracked, sent, or received in endpoint 20(1), server 40, and security-enabled computing system 800 could be provided in any storage structure including, but not limited to, a repository, database, register, queue, table, cache, etc., all of which could be referenced at any suitable timeframe. Any such storage structures may also be included within the broad term ‘memory element’ as used herein.

In an example implementation, endpoint 20(1), server 40, and security-enabled computing system 800 include software to achieve (or to foster) the execution flow control and analysis activities, as outlined herein. In some embodiments, these telemetry and execution flow analysis and control activities may be carried out by hardware and/or firmware, implemented externally to these elements, or included in some other computing system to achieve the intended functionality. These elements may also include software (or reciprocating software) that can coordinate with other network elements or computing systems in order to achieve the intended functionality, as outlined herein. In still other embodiments, one or several elements may include any suitable algorithms, hardware, software, components, modules, interfaces, or objects that facilitate the operations thereof. Modules may be suitably combined or partitioned in any appropriate manner, which may be based on particular configuration and/or provisioning needs.

In certain example implementations, the functions outlined herein may be implemented by logic encoded in one or more tangible media (e.g., embedded logic provided in an ASIC, digital signal processor (DSP) instructions, hardware instructions and/or software (potentially inclusive of object code and source code) to be executed by a processor, or other similar machine, etc.), which may be inclusive of non-transitory computer-readable media. In an example, endpoint 20(1), server 40, and security-enabled computing system 800 may include one or more processors (e.g., processors 31, 41, and 820) that are communicatively coupled to memory elements and that can execute logic or an algorithm to perform activities as discussed herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an EPROM, an EEPROM) or an ASIC that includes digital logic, software, code, electronic instructions, or any suitable combination thereof. Any of the potential processing elements, agents, engines, managers, modules, and machines described herein should be construed as being encompassed within the broad term ‘processor.’

The architectures presented herein are provided by way of example only, and are intended to be non-exclusive and non-limiting. Furthermore, the various parts disclosed are intended to be logical divisions only, and need not necessarily represent physically separate hardware and/or software components. Certain computing systems may provide memory elements in a single physical memory device, and in other cases, memory elements may be functionally distributed across many physical devices. In the case of virtual machine managers or hypervisors, all or part of a function may be provided in the form of software or firmware running over a virtualization layer to provide the disclosed logical function.

Note that with the examples provided herein, interaction may be described in terms of two, three, or more computing systems (e.g., endpoints 20(1)-20(N), server 40, security-enabled computing system 800). However, this has been done for purposes of clarity and example only. In certain cases, it may be easier to describe one or more of the functionalities of a given set of flows by only referencing a limited number of computing systems, endpoints, and servers. Moreover, the system for analyzing and controlling execution flow is readily scalable and can be implemented across a large number of components (e.g., multiple endpoints, servers, security-enabled computing systems), as well as more complicated/sophisticated arrangements and configurations. Accordingly, the examples provided should not limit the scope or inhibit the broad teachings of the private data protection system as potentially applied to a myriad of other architectures.

It is also important to note that the operations in the preceding flowcharts and diagrams illustrating interactions (i.e., FIGS. 2-7 and 10), illustrate only some of the possible execution flow analysis and control activities that may be executed by, or within, telemetry feedback system 100 and security-enabled computing system 800. Some of these operations may be deleted or removed where appropriate, or these operations may be modified or changed considerably without departing from the scope of the present disclosure. In addition, the timing of these operations may be altered considerably. For example, the timing and/or sequence of certain operations may be changed relative to other operations to be performed before, after, or in parallel to the other operations, or based on any suitable combination thereof. The preceding operational flows have been offered for purposes of example and discussion. Substantial flexibility is provided by embodiments described herein in that any suitable arrangements, chronologies, configurations, and timing mechanisms may be provided without departing from the teachings of the present disclosure.

As used herein, unless expressly stated to the contrary, use of the phrase ‘at least one of’ refers to any combination of the named elements, conditions, or activities. For example, ‘at least one of X, Y, and Z’ is intended to mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z. Additionally, unless expressly stated to the contrary, the terms ‘first’, ‘second’, ‘third’, etc., are intended to distinguish the particular nouns (e.g., element, condition, module, activity, operation, claim element, etc.) they modify, but are not intended to indicate any type of order, rank, importance, temporal sequence, or hierarchy of the modified noun. For example, ‘first X’ and ‘second X’ are intended to designate two separate X elements that are not necessarily limited by any order, rank, importance, temporal sequence, or hierarchy of the two elements.

### Other Notes and Examples

The following examples pertain to embodiments in accordance with this specification. Example T1 provides an apparatus, a system, one or more machine readable storage mediums, a method, and/or hardware-, firmware-, and/or software-based logic for controlling code flow, where the Example of T1 is to decompile object code of a software program on an endpoint to identify one or more branch instructions; receive a list of one or more modifications associated with the object code, where the list of one or more modifications is based, at least in part, on telemetry data related to an execution of corresponding object code on at least one other endpoint; and modify the object code based on the list and the identified one or more branch instructions to create new object code.

In Example T2, the subject matter of Example T1 can optionally include that the one or more modifications in the list are based, in part, on other telemetry data related to an execution of the object code on the endpoint.

In Example T3, the subject matter of any one of Examples T1-T2 can optionally include to cause the new object code to be loaded for execution.

In Example T4, the subject matter of any one of Examples T1-T3 can optionally include that a branch instruction of the one or more branch instructions is identified based, at least in part, on an absence of an instruction in the object code that validates the branch instruction.

In Example T5, the subject matter of any one of Examples T1-T4 can optionally include to add an instruction to a first location in the object code to validate a branch instruction, where the first location is indicated in the list.

In Example T6, the subject matter of any one of Examples T1-T5 can optionally include to remove an instruction that validates a branch instruction at a second location in the object code, where the second location is indicated in the list.

In Example T7, the subject matter of any one of Examples T1-T6 can optionally include that the telemetry data identifies one or more locations in the corresponding object code where one or more branch instructions were executed, respectively, during the execution on the other endpoint.

In Example T8, the subject matter of any one of Examples T1-T7 can optionally include to collect local telemetry data from one or more sources on the endpoint, where the local telemetry data is related to the new object code executing on the endpoint, and communicate at least some of the local telemetry data to a server.

In Example T9, the subject matter of Example T8 can optionally include that the one or more sources of local telemetry data include at least one of a processor trace mechanism and a central processing unit (CPU) last branch record.

In Example T10, the subject matter of any one of Examples T1-T9 can optionally include to receive an updated list of one or more other modifications, and dynamically modify the new object code according to the updated list, where the updated list of one or more other modifications is based, at least in part, on other telemetry data.

In Example T11, the subject matter of Example T10 can optionally include that dynamically modifying the new object code is to include rendering a portion of the new object code non-executable, performing the one or more other modifications of the updated list to the non-executable portion of the new object code, and subsequent to performing the one or more other modifications, rendering the non-executable portion of the new object code executable.

In Example T12, the subject matter of Example T11 can optionally include that the performing the one or more other modifications to the non-executable portion of the new object code includes using one of binary translation or binary rewriting to dynamically perform the one or more other modifications.

Example S1 provides a system for analyzing and controlling code flow, comprising a server comprising first logic and a second endpoint communicatively coupled to the server, the first logic to receive telemetry data related to first object code executing on a first endpoint, identify one or more locations in the first object code corresponding to one or more branch instructions, generate a list of one or more modifications to be made to second object code on the second endpoint based, at least in part, on the identified one or more locations; and the second endpoint to receive the list of one or more modifications from the server, and create new object code by modifying the second object code based, at least in part, on the list of one or more modifications.

In Example S2, the subject matter of Example S1 can optionally include that at least one of the one or more modifications in the list indicate an instruction to be added to the second object code to validate a branch instruction.

In Example S3, the subject matter of any one of Examples S1-S2 can optionally that the second endpoint is further to collect local telemetry data from one or more sources on the second endpoint, where the local telemetry data is related to the new object code executing on the second endpoint, and communicate at least some of the local telemetry data to a server.

In Example S4, the subject matter of Example S3 can optionally include that the first logic of the server is to aggregate the local telemetry data with other telemetry data related to one or more other instances of corresponding object code executing on one or more other endpoints, respectively, and generate an updated list of one or more modifications to be made to the new object code.

In Example S5, the subject matter of any one of Examples S1-S4 can optionally include that the second endpoint is further to receive an updated list of one or more modifications from the server while the new object code is executing on the second endpoint, and dynamically modify the new object code according to the updated list of one or more modifications to create updated object code.

Example X1 provides an apparatus, a system, one or more machine readable storage mediums, a method, and/or hardware-, firmware-, and/or software-based logic for analyzing and controlling code flow, where the Example X2 is to receive telemetry data related to object code executing on an endpoint; identify one or more locations in the object code associated with respective occurrences of a branch instruction, where the identification is based, at least in part, on the telemetry data; generate a list of one or more modifications to be made to the object code based, at least in part, on the identified one or more locations; and send the list to at least one endpoint of a plurality of endpoints.

In Example X2, the subject matter of Example X1 can optionally include that one or more branch instructions of the respective occurrences are not validated by respective validation instructions.

In Example X3, the subject matter of Example X2 can optionally include that the list includes an indication to add a validation instruction to the object code to validate at least one of the one or more branch instructions.

In Example X4, the subject matter of any one of Examples X1-X3 can optionally include that at least one branch instruction is validated by a validation instruction at a particular location in the object code.

In Example X5, the subject matter of Examples X4 can optionally include that the list includes an indication to remove the validation instruction from the object code, where subsequent to the validation instruction being removed from the object code, absence of the validation instruction is to cause an exception to be generated based on the object code attempting to execute the at least one branch instruction.

In Example X6, the subject matter of any one of Examples X1-X5 can optionally include to aggregate the telemetry data with other telemetry data related to corresponding object code executed on one or more other endpoints.

In Example X7, the subject matter of Example X6 can optionally include to create a memory map of a process associated with the object code executed on the endpoint.

In Example X8, the subject matter of Example X7 can optionally include to compare two or more branches indicated in the telemetry data with respective two or more branches indicated in the other telemetry data, and determine the one or more modifications based, at least in part, on the memory map and the comparison of the two or more branches.

In Example X9, the subject matter of any one of Examples X1-X8 can optionally to tailor the one or more modifications for the at least one endpoint based, at least in part, on information related to the at least one endpoint.

In Example X10, the subject matter of Example X9 can optionally include that the information includes at least one of one or more software programs installed on the at least one endpoint, a type of the at least one endpoint, and a policy.

Example M1 provides an apparatus, a system, one or more machine readable storage mediums, a method, and/or hardware-, firmware-, and/or software-based logic for analyzing and controlling code flow, where the Example M1 is to pause execution of a program on a computing system; determine verification metadata associated with the program, the verification metadata indicated in a metadata sub-page region associated with a primary sub-page region; determine actual metadata associated with the execution of the program; and generate a notification based on the verification metadata not corresponding to the actual metadata.

In Example M2, the subject matter of Example M1 can optionally include to obtain the verification metadata subsequent to the program being loaded for execution and prior to the execution of the program, and populate the at least one metadata sub-page region with the verification metadata.

In Example M3, the subject matter of any one of Examples M1-M2 can optionally include that the program is paused based on an occurrence of a checkpoint during the execution of the program.

In Example M4, the subject matter of any one of Examples M1-M3 can optionally include to verify the execution based on the verification metadata corresponding to the actual metadata, and resume the execution of the program.

In Example M5, the subject matter of any one of Examples M1-M4 can optionally include to identify one or more anomalies based on the verification metadata not corresponding to the actual metadata, where the notification identifies the one or more anomalies.

In Example M6, the subject matter of any one of Examples M1-M5 can optionally include that the verification metadata includes a first linear address mapped to a physical address of the primary sub-page region, and where the actual metadata includes a second linear address mapped to the same physical address of the sub-page region.

In Example M7, the subject matter of Example M6 can optionally include to determine the verification metadata does not correspond to the actual metadata based on the first linear address being different than the second linear address.

In Example M8, the subject matter of any one of Examples M1-M7 can optionally include that the verification metadata includes first cryptographic information derived by applying a cryptographic algorithm to at least some contents in the primary sub-page region.

In Example M9, the subject matter of Example M8 can optionally include to determine the verification metadata does not correspond to the actual metadata based on the first cryptographic information in the metadata sub-page region not corresponding to second cryptographic information derived from at least some of current contents in the primary sub-page region subsequent to the execution of the program being paused.

In Example M10, the subject matter of any one of Examples M1-M9 can optionally include that the metadata sub-page region is adjacent to the primary sub-page region in a memory page.

In Example M11, the subject matter of any one of Examples M1-M10 can optionally include to pause the program executing on the computing system based on a request for an additional primary sub-page region to be dynamically allocated for the program, obtain second verification metadata for the additional primary sub-page region, populate a second metadata sub-page region adjacent to the additional primary sub-page region, configure a second checkpoint in the program, the second checkpoint associated with an instruction to access the additional primary sub-page region, and resume execution of the program.

Example Y1 provides an apparatus for analyzing and/or controlling code flow, where the apparatus comprises means for performing the method of any one of the preceding Examples.

In Example Y2, the subject matter of Example Y1 can optionally include that the means for performing the method comprises at least one processor and at least one memory element.

In Example Y3, the subject matter of Example Y2 can optionally include that the at least one memory element comprises machine readable instructions that when executed, cause the apparatus to perform the method of any one of the preceding Examples.

In Example Y4, the subject matter of any one of Examples Y1-Y3 can optionally include that the apparatus is one of a computing system or a system-on-a-chip.

Example Y5 provides at least one machine readable storage medium comprising instructions for analyzing and/or controlling code flow, where the instructions when executed realize an apparatus or implement a method as in any one of the preceding Examples.

What is claimed is:

1. At least one machine readable storage medium comprising code, wherein the code, when executed by at least one processor, cause the at least one processor to:
decompile object code of a software program on an endpoint to identify one or more branch instructions;
receive a list of one or more modifications associated with the object code, wherein the list of one or more modifications is based, at least in part, on telemetry data related to an execution of corresponding object code on at least one other endpoint; and
modify the object code based on the list and the identified one or more branch instructions to create new object code.

2. The at least one machine readable storage medium of claim 1, wherein the one or more modifications in the list are based, in part, on other telemetry data related to an execution of the object code on the endpoint.

3. The at least one machine readable storage medium of claim 1, wherein the code, when executed by the at least one processor, further causes the at least one processor to:
cause the new object code to be loaded for execution.

4. The at least one machine readable storage medium of claim 1, wherein a branch instruction of the one or more branch instructions is identified based, at least in part, on an absence of an instruction in the object code that validates the branch instruction.

5. The at least one machine readable storage medium of claim 1, wherein the code, when executed by the at least one processor, further causes the at least one processor to:
add an instruction to a first location in the object code to validate a branch instruction, wherein the first location is indicated in the list.

6. The at least one machine readable storage medium of claim 1, wherein the code, when executed by the at least one processor, further causes the at least one processor to:
remove an instruction that validates a branch instruction at a second location in the object code, wherein the second location is indicated in the list.

7. The at least one machine readable storage medium of claim 1, wherein the telemetry data identifies one or more locations in the corresponding object code where one or more branch instructions were executed, respectively, during the execution on the other endpoint.

8. The at least one machine readable storage medium of claim 1, wherein the code, when executed by the at least one processor, further causes the at least one processor to:
collect local telemetry data from one or more sources on the endpoint, wherein the local telemetry data is related to the new object code executing on the endpoint; and
communicate at least some of the local telemetry data to a server.

9. The at least one machine readable storage medium of claim 1, wherein the one or more sources of local telemetry data include at least one of a processor trace mechanism and a central processing unit (CPU) last branch record.

10. The at least one machine readable storage medium of claim 1, wherein the code, when executed by the at least one processor, causes the at least one processor to:
receive an updated list of one or more other modifications; and
dynamically modify the new object code according to the updated list, wherein the updated list of one or more other modifications is based, at least in part, on other telemetry data.

11. The at least one machine readable storage medium of claim 10, wherein dynamically modifying the new object code is to include:
rendering a portion of the new object code non-executable;
performing the one or more other modifications of the updated list to the non-executable portion of the new object code; and
subsequent to performing the one or more other modifications, rendering the non-executable portion of the new object code executable.

12. The at least one machine readable storage medium of claim 11, wherein the performing the one or more other modifications to the non-executable portion of the new object code includes using one of binary translation or binary rewriting to dynamically perform the one or more other modifications.

13. An apparatus for controlling code flow, comprising:
at least one processor; and
logic coupled to the processor for execution by the processor, the logic to:
decompile object code of a software program on the apparatus to identify one or more branch instructions;
receive a list of one or more modifications associated with the object code, wherein the list of one or more modifications is based, at least in part, on telemetry data related to an execution of corresponding object code on at least one other endpoint; and
modify the object code based on the list and the identified one or more branch instructions to create new object code.

14. The apparatus of claim 13, wherein the one or more modifications in the list are based, in part, on other telemetry data related to an execution of the object code on the endpoint.

15. The apparatus of claim 13, wherein the logic is further to:
add an instruction to a first location in the object code to validate a branch instruction, wherein the first location is indicated in the list.

16. The apparatus of claim 13, wherein the logic is further to:
remove an instruction that validates a branch instruction at a second location in the object code, wherein the second location is indicated in the list.

17. The apparatus of claim 13, wherein the logic is further to:
collect local telemetry data from one or more sources on the apparatus, wherein the local telemetry data is related to the new object code executing on the at least one processor; and
communicate at least some of the local telemetry data to a server.

18. A method, comprising:
decompiling object code of a software program on an endpoint to identify one or more branch instructions;
receiving a list of one or more modifications associated with the object code, wherein the list of one or more modifications is based, at least in part, on telemetry data related to an execution of corresponding object code on at least one other endpoint; and
modifying the object code based on the list and the identified one or more branch instructions to create new object code.

19. The method of claim 18, further comprising:
adding an instruction to a first location in the object code to validate a branch instruction, wherein the first location is indicated in the list.

20. A system for analyzing and controlling code flow, the system comprising:
a server comprising first logic to:
receive telemetry data related to first object code executing on a first endpoint;
identify one or more locations in the first object code corresponding to one or more branch instructions;
generate a list of one or more modifications to be made to second object code on a second endpoint based, at least in part, on the identified one or more locations; and
the second endpoint communicatively coupled to the server, the second endpoint to:
receive the list of one or more modifications from the server; and
create new object code by modifying the second object code based, at least in part, on the list of one or more modifications.

21. The system of claim 20, wherein at least one of the one or more modifications in the list indicate an instruction to be added to the second object code to validate a branch instruction.

22. The system of claim 20, wherein the second endpoint is further to:
collect local telemetry data from one or more sources on the second endpoint, wherein the local telemetry data is related to the new object code executing on the second endpoint; and
communicate at least some of the local telemetry data to a server.

23. The system of claim 21, wherein the first logic of the server is further to:
aggregate the local telemetry data with other telemetry data related to one or more other instances of corresponding object code executing on one or more other endpoints, respectively; and
generate an updated list of one or more modifications to be made to the new object code.

24. The system of claim 20, wherein the second endpoint is further to:
receive an updated list of one or more modifications from the server while the new object code is executing on the second endpoint; and
dynamically modify the new object code according to the updated list of one or more modifications to create updated object code.

25. At least one machine readable storage medium comprising executable instructions, wherein the instructions, when executed by at least one processor, cause the at least one processor to:
pause execution of a program on a computing system;
determine verification metadata associated with the program, the verification metadata indicated in a metadata sub-page region associated with a primary sub-page region;
determine actual metadata associated with the execution of the program; and
generate a notification based on the verification metadata not corresponding to the actual metadata.
